(19) United States
(12) Patent Application Publication
(10) Pub. No.: US 2013/0073278 A1
(43) Pub. Date: Mar. 21, 2013

(54) METHODS AND SYSTEMS FOR COMPILING COMMUNICATION FRAGMENTS AND CREATING EFFECTIVE COMMUNICATION

(71) Applicant: Heather Mills, Burien, WA (US)

(72) Inventor: Heather Mills, Burien, WA (US)

(73) Assignee: PKET LLC, Burien, WA (US)

(21) Appl. No.: 13/239,141

(22) Filed: Sep. 21, 2011

(51) Int. Cl. G06F 17/27

(52) U.S. Cl. 704/9

(57) ABSTRACT

Methods and systems for forming a communication. At least one variable identifying an area of communication is received. Then, information associated with one or more users is received. A plurality of variables, each variable relevant to forming a communication within a communication category are received. A communication structure is generated based on at least two of the received variable identifying the area of communication, the received user information or the received plurality of variables. Communication fragments are identified based on the generated communication structure. Communication fragments are selected from those identified. A communication is formed based upon the selected communication fragments. Then, the formed communication is outputted.

### RELATED APPLICATIONS

This application is related to application Ser. No. ______ filed concurrently herewith, Attorney Docket No. HMIL 1-1001; and application Ser. No. ______ filed concurrently herewith, Attorney Docket No. HMIL 1-1003 and are incorporated herein by reference.

### BACKGROUND OF THE INVENTION

Communication attempts to convey a message, provide feedback, communicate feelings, provide inspiration, or elicit a reaction from the receiver. The sender expects the communication will be partially or completely effective. There are many variables at play in communication to determine if its intent will be realized. These variables are often overlooked due to factors including lack of time, the inability of the sender to express himself adequately, the receivers inability to provide honest or proper direction to the sender regarding his communication needs or to the senders inability to properly incorporate that direction into future correspondence due to lack to time, desire or ability. Therefore, communication is often ineffective, including electronic communication.

### SUMMARY OF THE INVENTION

The present invention provides systems and methods for improving communication. An exemplary method includes identifying the communication preferences of a sender and a receiver, identifying the gaps of the two personalities, identifying how the receiver perceives the sender (hidden information), gathering historical data of the type of communications between these two types of communicators at the current ranking and preferences of the receiver, and proposing the current communication between these two individuals. After the preferences and rankings are identified, the general category of communication, and the refined category of the communication are selected. Once this selection happens, a suggestion is offered of the communication that is expected to result in the most satisfaction from the receiver based on historical data.

In one aspect of the invention, a sender who is unable or unwilling to send the program generated communication would customize the communication by choosing from predefined variables. The variables will define the structure and text of the communication, which can then be sent to the receiver in a tangible form.

### BRIEF DESCRIPTION OF THE DRAWINGS

Preferred and alternative examples of the present invention are described in detail below with reference to the following drawings:

FIG. 1 is a schematic diagram of a system formed in accordance with an embodiment of the present invention;

FIG. 2 shows a table illustrating example text equivalents used in the present invention;

FIG. 3 is a screen shot of a user interface formed in accordance with an embodiment of the present invention;

FIGS. 4-6 show tables of exemplary contents of a database formed in accordance with an embodiment of the present invention;

FIG. 7 illustrates a flowchart of an exemplary process for determining which text fragment equivalents are shown based upon a length rating;

FIGS. 8-12 show tables of exemplary contents of a database formed in accordance with an embodiment of the present invention;

FIG. 13 is a diagram illustrating a completed communication, organized by the structure defined in the database;

FIGS. 14-1 and 14-2 are diagrams illustrating a relationship in an exemplary database of variables, text fragment equivalents, Master Groups and Dependent Groups;

FIG. 15 is a flowchart of a process for identifying text fragment equivalents by matching Inputs, Master Groups, and/or Dependent Groups;

FIG. 16 is a flowchart of a process for gathering information from the communication service database and the receiver's survey;

FIG. 17 is an exemplary table illustrating how the empirical database would identify a specific communication;

FIG. 18 is an exemplary table illustrating an alternate method of how the empirical database would identify a specific communication;

FIG. 19 is an exemplary table illustrating descriptions of fields to be used to gather personal information and preferences;

FIG. 20 is an exemplary table illustrating personal information and preferences of a sender and receiver;

FIG. 21 is an exemplary table illustrating descriptions of fields to be used for survey question descriptions;

FIG. 22 is an exemplary table illustrating responses to a survey;

FIG. 23 illustrates the areas of originating data;

FIG. 24 illustrates a method for providing communication from two senders to one receiver, with the receiver responding to the sender and providing responses to the receiver's survey;

FIG. 25 provides an illustrative diagram of a communication service and the relationships between different functional components in accordance with an embodiment of the present invention;

FIG. 26 provides an illustrative diagram of a communication service and the relationships between different functional components in accordance with an embodiment the present invention;

FIG. 27 is a flowchart of an exemplary process of sending an initial communication;

FIG. 28 is a flowchart of a process of updating the empirical database after a communication is received;

FIG. 29 is a screen shot of the log in page upon entering the communication service;

FIG. 30 is a screen shot of a home page for the user;

FIG. 31 is a screen shot of a received communications page;

FIG. 32 is a screen shot of a communication provided page;

FIG. 33 is a screen shot of a To-Do List page;

FIG. 34 is a screen shot of a page that a user sees when a communication has been received;

FIG. 35 is a screen shot of a receivers response and survey page;

FIG. 36 is a screen shot of an identifying relationships of users page;

FIG. 37 is a screen shot of a page used to initiate communication;

FIG. 38 is a screen shot of a user profile and preferences page; and

FIG. 39 is a screen shot of a user survey preferences page.

### DETAILED DESCRIPTION OF THE PREFERRED EMBODIMENT

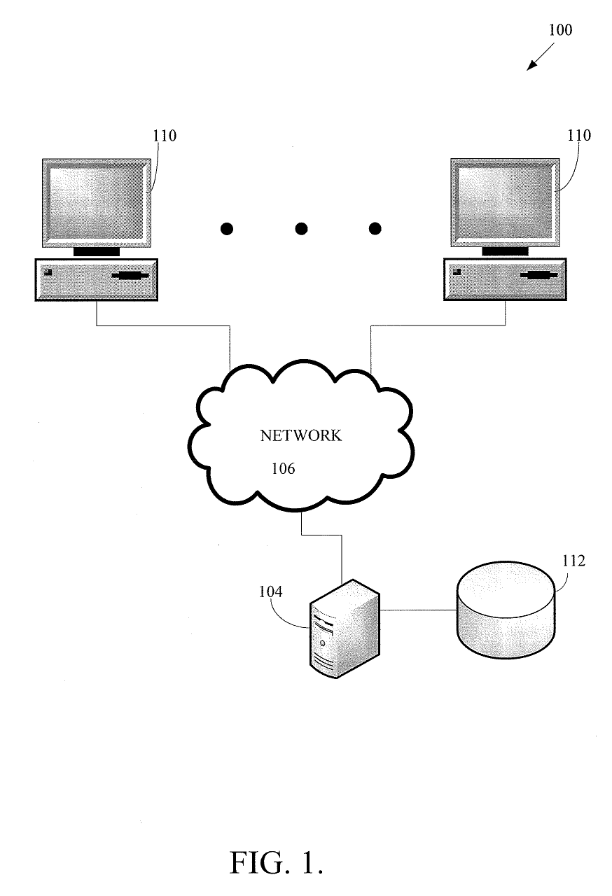

The present invention provides methods and systems for compiling communication fragments and creating effective communication. FIG. 1 shows an exemplary system 100 that includes a processor 104 that is in data communication over a public or private data network 106 with a plurality of computer-based devices 110. The computer-based devices 110 may take a variety of different embodiments, such as personal computer, personal data assistant (PDA), tablet device, smart phone, or any device capable of receiving data from the network 106 and present the received data to a viewer.

In one embodiment, the processor 104 employs empirical data to identify and select the best communication from a database 112 to be sent to a receiver (via the devices 110) to enhance and improve satisfaction of the communication.

The processor 104 generates a communication site (i.e., website) utilizing social networking. The site includes a self-assessment phase which allows the user to enter their communication preferences and link to other users within the social network. After the sender and the receiver are linked, a gap analysis is performed based upon the differences in preferences to determine adjustments to communication style required of the sender.

The processor 104 determines the best communication available for the receiver, utilizing information input by the receiver which may include 1) hidden assessments of the sender (based on feedback of prior receiver(s)), 2) the receivers communication preferences, 3) the receivers current performance rating, and 4) the receivers gender characteristics.

The processor 104 offers customized communication from the sender including, for example, determination of group of communication, determination of category of communication, determination of specifics to address, customization based on criteria offered such as:

i. Length of communication

ii. Current Performance Ranking or Satisfaction Ranking

iii. Extent focused on feelings vs thinking

iv. Extent delivered in professional manner or terminology vs. casual

v. Extent motivated by team dynamics

vi. Or switch out the feedback for another equally correlated feedback
1. The sender can choose to write his own feedback and offer to have it published in the database with him receiving credit for writing it

After a communication is sent to a receiver (i.e., the device 110), a receiver's home page is updated indicating different levels of participation, for example,
a. After communication is sent,
   vii. Amount of feedback received
   viii. Amount of awards received
b. After communication sent, receiver offers feedback
   ix. Feedback may include
      1. Optional written note to sender
      2. How the receiver feels about the communication
         a. Based on specified criteria including factors determining communication preferences type
         b. Feedback will update desired frequency from this sender in the sender's profile
         c. Feedback will update the receivers assessment of sender in the hidden fields
c. The receivers feedback and satisfaction is saved in the database creating empirical data
d. The receivers feedback updates scheduling template within the senders scheduling system
   x. Sender is prompted by email notification when each of his recipients needs additional communication
   xi. Sender receives suggested future communication based upon what is most likely to satisfy the receiver (based on empirical data and the receivers profile identification of areas desiring to receive communication on), sender can either simply approve proposed communication, or can create an original communication

The processor 104 provides prewritten electronic communication with interchangeable sentence fragments to offer a plurality of communication options which can be quickly filtered and matched for a specific purpose and/or a particular receiver. Specifically, the invention:

For Senders of Communication:
a. Offers prewritten communication which can be sent “as is” after applying filters relating to type or category of communication;
b. Allows the sender to customize the prewritten communication by making a selection of user defined criteria that will alter the communication by taking the sentence fragments that are determined to be interchangeable, but which carry different characteristics, and exchange them with other selections by a mouse or keyboard click and/or drag technological equivalent;
c. Allows the sender to choose to edit (in most circumstances) the final proposed communication in order to personalize it further;

For Receivers of Communication:
d. Allows prospective receivers of communication to identify types or categories of communication that they would like to receive, and request it from another person(s) or from the system;
e. Allows receivers of communication to respond to yes/no, and multiple choice questions to record their satisfaction or dissatisfaction with the communication they have received based upon their communication preferences and their relationship to the sender (this satisfaction/dissatisfaction history is saved with each distinct combination of fragments comprising a communication), and

Attributes of the invention:
f. Allows use of empirical data of satisfaction/dissatisfaction of specific communication to recommend specific communication and/or specific frequency of communication between two members of the social network and/or community website either when a prospective sender enters the website or proactively by a recommendation sent to the prospective sender via email, tweet, etc., and g. Allows the system 100 to generate and distribute communication to receivers who have requested system 100 generated communication.

The following describes the invention, that when embodied as a process of combining Communication fragments together, forms a complete Communication. Communication fragments are stored in many separate tables in the database 112. In an embodiment, the fragments are text based. Other embodiments may provide audio and visual Communication fragments, or a combination of different media types. Additional examples of products produced by the process include, but are not limited to: an advertisement, advice, announcement, answer, bulletin, cartoon, choice, comic, command, Communication, correspondence, critique, feedback, greeting card, idea, letter, memorandum, message, note, presentation, program, publication, report, review, selection, song, speech, and statement.

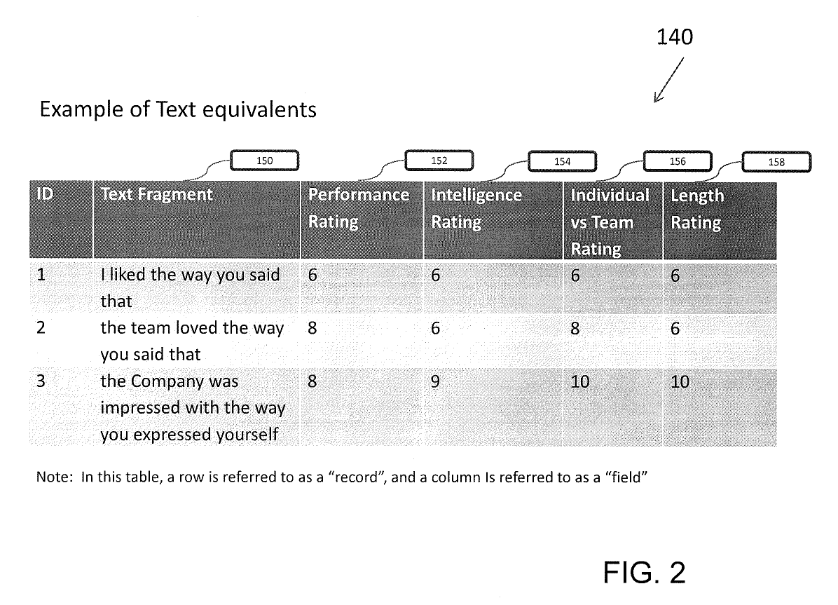

In a text-based embodiment, tables in the database 112 include a text fragment or fragments. The text fragments within the same field of a table are considered text equivalents. In other words, one text fragment may be placed in a sentence equally as well as another text fragment. Although the fragments are interchangeable, the fragments provide different meanings, convey different messages, express different feelings, etc. FIG. 2 shows an example of a table 140 of text fragments that are interchangeable.

Three different example text fragments are shown in column 150. The fragments are text equivalents, or fragments, with different ratings. The fragment in the first row shows the user's feeling that the Receiver of the Communication did a good job. This is identified as a value in a Performance Rating column 152. (For this embodiment, the Ratings scale available is 6 through 10). The fragment in the second row shows the user's feeling that the Receiver of the Communication did a great job. This is identified in the Performance Rating column 152 as an 8 value. In the final fragment, the value in the Performance Rating column 152 is 8. When the tables are created, there is some subjective nature in the Ratings. In addition to identifying the Performance, other Ratings are associated with these three fragments. For example, on the Rating scale previously identified, if the three fragments were to be rated based upon the intelligence of the vocabulary (Intelligence Rating column 154), the first two fragments would be low (6) and the last fragment (9) would be high. Another Rating, such as the spectrum between the Communication being personally from “me” versus the Communication being from a larger group would have Ratings as follows: “I”=6, “We”=7, “the team”=8, “the department”=9, “the company”=10, see column 156. When Rating the three fragments on the Individual vs. Team scale, they are rated as 6, 8, and 10. The last column 158 is a field for a Rating for Length. As illustrated above, the database 112 includes Communication Fragments each of which corresponds to various user preferred Ratings.

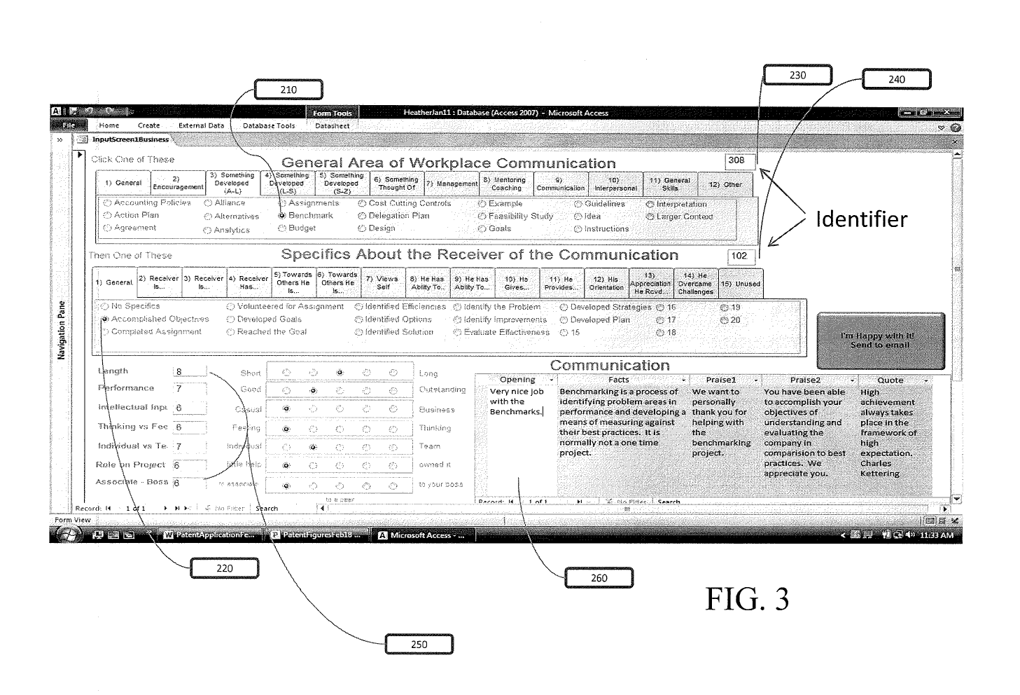

The numerous Communication Fragments embedded in the database shown above cannot be combined into a complete and meaningful communication without a structure. In order to provide the structure to determine which Communication can be combined, the first step is identifying a topic or purpose for the Communication. FIG. 3 shows an example of a screen shot of a webpage 200 generated by the processor 104 and accessed by a user at the device 110. It can be appreciated that, an application program when executed by a processing device generates the webpage 200 and any other webpage described later. This application program may reside partially or fully at the processor 104 (or memory associated with the processor 104) or at the device 110. The webpage 200 presents a communication created by the application program for a Receiver based on a number of Sender selections. At a first section 210, the user chooses a specific topic. A second section 220 allows the user to select specifics about the intended Receiver of the Communication. Other sections may be provided. The topics selected in the sections 210, 220 include table identifiers.

The Communication in this example is a Workplace Communication. Other groups of text Communication include Greeting Cards, Junior (for children), Religious, Addictions, and Self Help.

The general purpose in the example shown in FIG. 3 provides feedback on a “Benchmark” project as selected in section 210. The further refined purpose (section 220) in this example is to provide the Receiver of the Communication with feedback on the Receiver's role in the Benchmarking Project (“accomplished objectives”).

“Benchmark” selection (in the first section 210) has an identifier of 308 shown in window 230. “Accomplished Objectives” selection (in the second section 220) has an identified of 102 shown in window 240. In other words, if a user wanted to send someone Communication about a Benchmark Project, and they wanted to tell the Receiver that the Receiver Accomplished his Objectives, these two choices would be made. 308 102 forms the structure of this particular Communication. The structure (308, 102) is referred to as Critical Identification.

The first and second sections 210, 220 include a plurality of selections categorized under a plurality of topic tabs. In the first section 210, the selections fall under one of the following tabs: General, Encouragement, Something Developed, Something Thought of, Management, Mentoring Coaching, Communication, Interpersonal, General Skills, Other. In the second section 220, the selections fall under one of the following specifics about the Receiver tabs: General, Receiver is, Receiver has, Towards Others he is, Views Self, He has Ability to, He Gives, He Provides, His Orientation, Appreciation He Received, He Overcame Challenges.

No other Ratings are required to be chosen by the user, but additional Ratings may be chosen by the user in a third section 250 that provides a more customized Communication to the Receiver. For this example purposes, the general purpose will be referred to as the General Critical and the further refined purpose will be referred to as the Refined Critical.

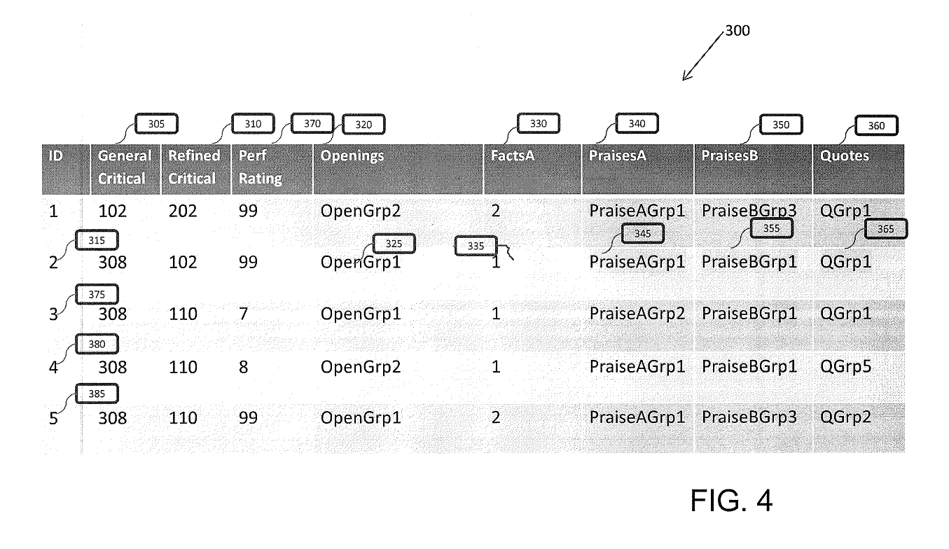

FIG. 4 is an example of a Master Table 300 in the database 112. In this embodiment, the table 300 includes one record 315 with 308, 102 as the Critical Identifier. The record 315 identifies the structure. In this example, the Master Table 300 identifies the structure of the sentence for 308 102 as: all records identified as “OpenGrp 1” (cell 325) shown in an “Openings” Table column 320; all records identified as Group “1” (cell 335) shown in a “FactsA” Table column 330; all records identified as “PraiseAGrp 1” (cell 345) shown in a “PraisesA” Table column 340; all records identified as “PraiseBGrp 1” (cell 355) shown in a “PraisesB” Table column 350; and all records identified as “QGrp 1” (cell 365) as shown in “Quotes” Table column 360.

In this example, there is an additional column for Performance Rating column 370, which is retrieved from the section 250 of FIG. 3. The entry of “99” in this field is considered a wildcard, meaning any user input into the Performance Rating is acceptable.

In another embodiment, instead of a having the five Groups 320-360 and the Performance Rating field column 370, a Structure Group field will be available. This example is simplified, in that the Master Table 300 is defining the structure. In a more complex example, the Master Table 300 defines Structure Groups, then after the program chooses a structure group, it would go to the specified table, and the structure would be defined by that table. In this way, Communications can be compiled in many different structures and the user would not be able to anticipate the structure of the Communication.

Under other circumstances, more than one record matching the Critical Identifier(s) may be available. Notice that if Critical identifier 308 110 were chosen, there are three possible structures available (record 3, record 4 and record 5) 375, 380, 385. Under that circumstance, there may be a Rating in the Master Table defining a priority that will cause one of the structures to be selected over another. In this embodiment, one of the three rows 375, 380, 385 are selected randomly.

Additional Ratings can be defined by the user in a database form FIG. 3. Different Rating descriptions will be applicable to different Communication Groups. Ratings for Workplace Communication may include Length, Performance, Intellectual, Thinking vs. Feeling, Individual vs. Team, Role on Project, and Associate vs. Boss as shown in section 250 of FIG. 3. These Ratings would not apply to Personal Communication like for Birthdays, or for Self-Help Communication on dealing with Grief The user would have the option to respond to each of the Ratings using a 6-10 response scale. Once the user has responded to one or more of the Ratings, the completed Communication would immediately be displayed in a Communication review section 260 for review by the user. The following is a step-by-step analysis of how the program arrives at a complete Communication.

Assume the user responded to the Ratings in the manner shown in FIG. 3: Length=8, Performance=7, Intellectual=6, Thinking vs. Feeling=6, Individual vs. Team=7, Role on Project=6, Associate vs. Boss=6 250.

As previously determined, the structure of this completed Communication is defined by the second record shown in FIG. 4. The components of the structure will be referred to as Segments. How each of the five Segments determines which Fragments to include is described below. In other words, a Segment is a Master Group that will most likely include several or many Fragments.

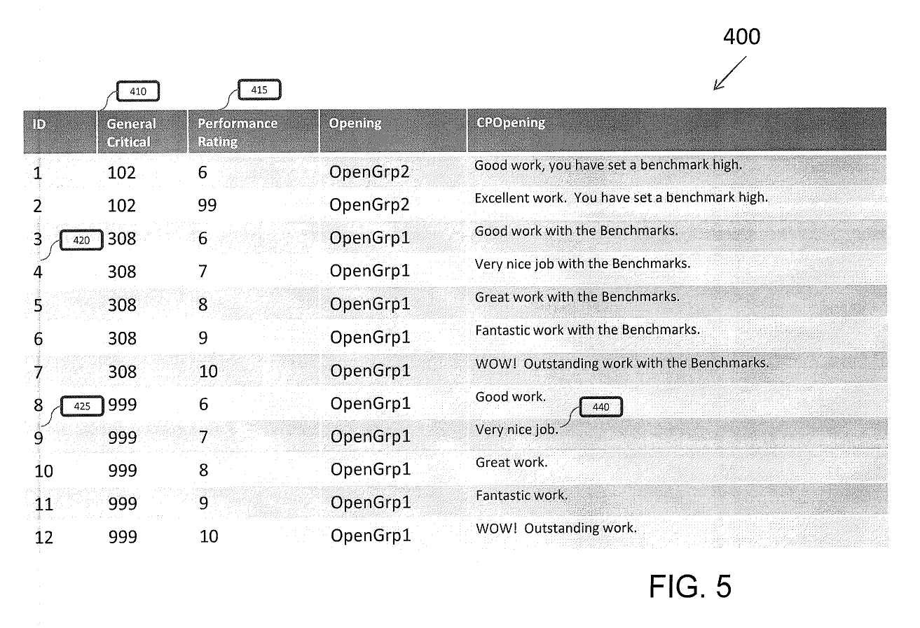

To determine what will be included as the Openings segment, the system reviews the “Openings” Table 400 shown in FIG. 5. In this embodiment, “99” or “999” is treated as a wildcard and will be returned as a possible Fragment or Group no matter what Rating has been entered by the user for a particular Rating variable. In the selections shown in FIG. 3, the General Critical value 410 is matched to the General Critical Input of 308 (window 230) and the Performance Rating value 415 is matched with the Performance Rating Input of 7 (section 250), therefore the Fragment options are ID 4 (record 420) and ID 9 (record 425). In one embodiment, there would be a preference to choose one option over the other. For example, it is preferable to select ID 4 before selecting the wildcard because it more closely matches the user's Inputs. In another embodiment one of the two options would be randomly selected when arriving at the final combined Communication. For our example, ID 9, “Very nice job.” cell 440 is chosen. Note that the Table 400 in FIG. 5 includes the Performance Rating as the only variable other than the General Critical variable. This is for example purposes only as this (or any) table could include more than one variable, or it could include additional fields from the Critical Identifier.

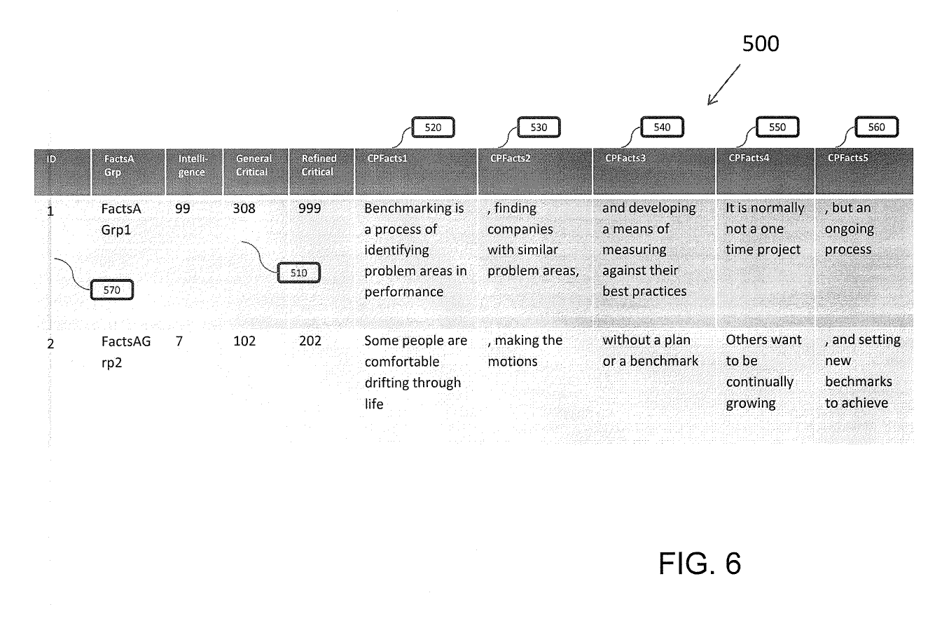

To determine what will be included as the FactsA Segment, the “FactsA” Table 500 shown in FIG. 6 is reviewed by the program. In our example, the General Critical is 308 cell, 510, therefore the Segment for FactsA will be comprised of five pieces of Fragments as shown for a first record 570:

CPFacts1 (Column 520): Benchmarking is a process of identifying problem areas in performance,

CPFacts2 (Column 530): finding companies with similar problem areas, CPFacts3 (Column 540): and developing a means of measuring against their best practices;

CPFacts4 (Column 550): It is normally not a one-time project,

CPFacts5 (Column 560): but an ongoing process.

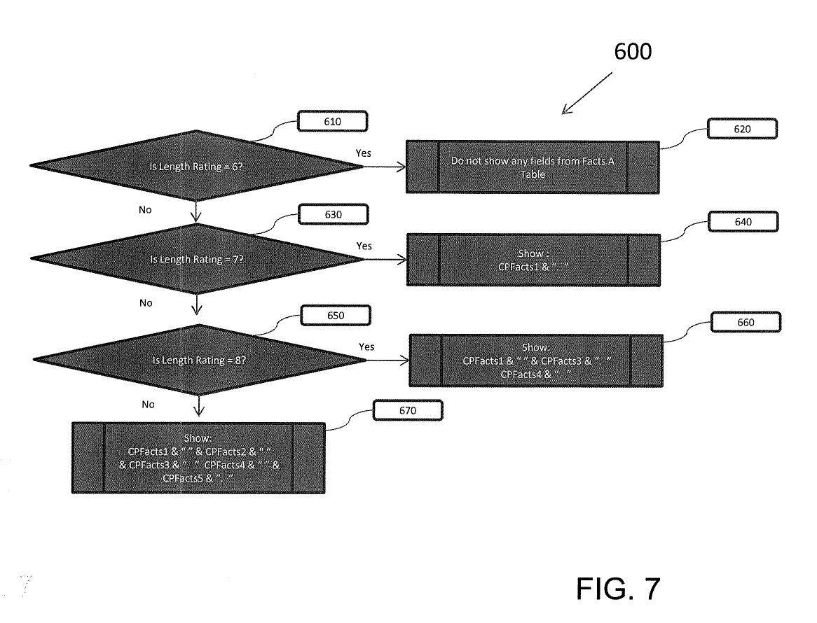

The FactsA Segment will remain in five separate Fragments. The Fragments are written to allow for certain Fragments to be dropped out of the Segment while the remaining Fragments are still a complete thought. The purpose for this is to allow the user to designate if they would like a brief Communication or a longer Communication. FIG. 7 shows the process 600 that uses the Length Rating that the user entered at section 250 of the database form 200 to determine the Fragments from the table 500 to be included in the complete Communication. For example, if Length=6 was input as determined at decision block 610, nothing would show from the table 500, block 620. Certain Fragments are written to be a complete sentence on their own. If Length=7 was input as determined at decision block 630, CPFacts1 is the only output, block 640. CPFacts1 and CPFacts3 combined could be a complete sentence, and CPFacts4 is a complete sentence. These two complete sentences would show (block 660) if Length=8 as input as determined at decision block 650. (During the process of combining Fragments, punctuation and spaces are added as required.) When Length=9 or Length=10 is input, CPFacts2 and CPFacts5 are added, block 670. In this fashion, the variables shown in the FactsA Table 500 are interactive with the Length variable although the Length variable is not shown in the table, but accounted for in the processing of the data to arrive at the complete Communication. Because Length=8 was chosen in section 250, the output is CPFacts 1 and CPFacts 3 combined, and CPFacts4. The process will vary depending on the Structure identified in the Master Table or by a Structure Group. In this embodiment, the process shown in FIG. 7 would apply to all Communications generated using the Master Table 300 provided in FIG. 4.

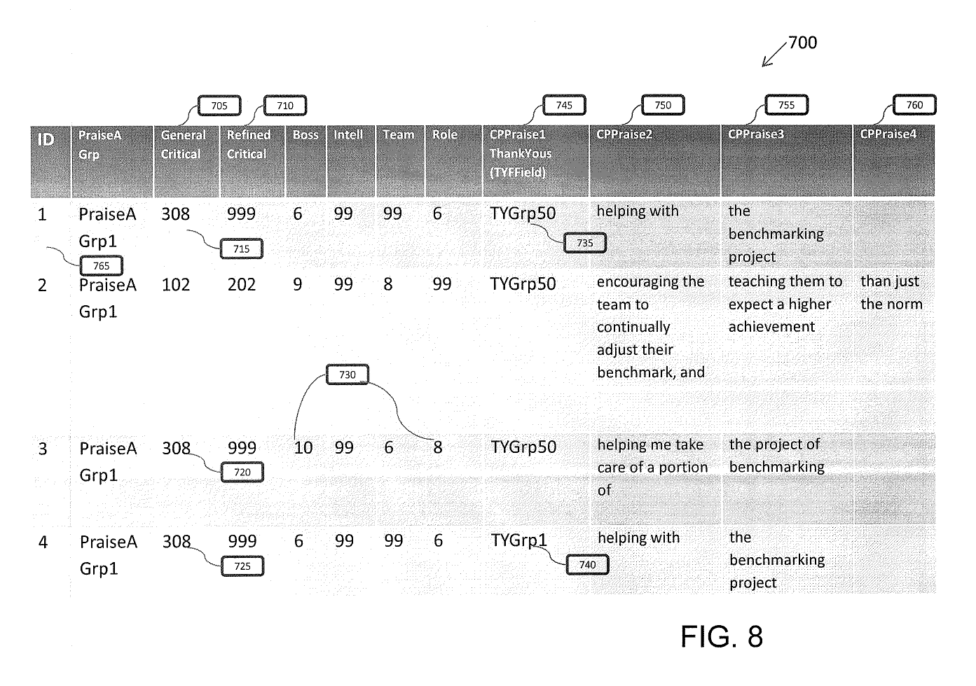

To determine what Fragments and/or Group(s) will be included in the PraisesA Segment, a “PraisesA” table 700 in FIG. 8 is reviewed. In this example, the records in the table 700 with a matching General Critical of 308 Column, 705 and the Refined Critical of 102 Column, 710 are found. The Segment for PraisesA includes Fragments and/or Group(s) included in record ID #1 715, ID #3 720 or ID #4 725. 999 is a wildcard. Recalling that the user entered Ratings for Boss and Role as Rating=6 for both in section 250, ID #3 is eliminated as an option because its Ratings for Boss and Role cells 730 do not match. In this instance, both records ID #1 and ID #4, are selected. CPPraise4 760 is unused for #1 and #4 (the field is blank), and CPPraise1 Column 745 has a special use.

Further analyzing ID #1, rather than including a Fragment, CPPraise1 refers to another table (“ThankYous”) and identifies that the records matching the Group on that table called “TYGrp50” cell 735 will fit into this CPPraise1 Fragment. ID #4 also states that any record matching group on the ThankYous table called “TYGrp l” cell 740 will fit into this CPPraise1 Fragment. The following are the options from the analysis:

For ID #1:

CPPraise1 Column 745: Identify a record from ThankYous Table, within the TYGrp50

CPPraise2 Column 750: helping with

CPPraise3 Column 755: the benchmarking project

CPPraise4 Column 760: (unused in this instance)

For ID #4:

CPPraise1 Column 745: Identify a record from the ThankYous Table, within the TYGrpl

CPPraise2 Column 750: helping with

CPPraise3 Column 755: the benchmarking project

CPPraise4 Column 760: (unused in this instance)

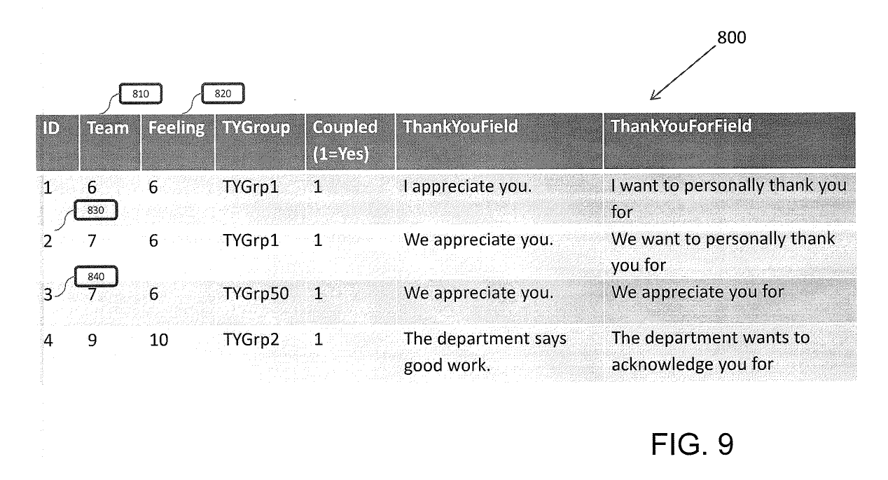

At this point, there are two options where the entire Segment for PraisesA has been determined except for what will be identified to be used for Fragment CPPraise1. To determine what will be included in the CPPraise1 field for each option, the “ThankYous” table 800 shown in FIG. 9 is reviewed. In the above example, two ThankYou combinations are possible when the input at section 250 is Team=7 column 810 and Feeling=6 column 820. The two combinations are ID #2 and ID #3:

Row 830 ThankYou field: “We appreciate you”. ThankYouFor field: “We want to personally thank you for” and

Row 840 ThankYou field: “We appreciate you”. ThankYouFor field: “We appreciate you for”.

In this example, the ThankYou field and ThankYouFor field in record ID #2 would remain together if record ID #2 is selected to be added to the complete Communication. Similarly the ThankYou field and ThankYouFor field in record ID #3 would remain together if record ID #3 is selected to be added to the complete Communication. In other embodiments they may be separated.

In this embodiment, the two options for ThankYous continue to have the two Fragments tracking together. One Fragment, the ThankYouFor field will populate the CPPraise1 Fragment which will complete the PraisesA Segment. The remaining Fragment, the ThankYou field may be called upon in other tables in the structure identified in the Master Table 300.

For each Segment, consideration has to be given to the length of the Segment, as shown in FactsA above, and in FIG. 7. In this embodiment, PraisesA requires all three fields to create a complete sentence. It will either be shown in its entirety, or not shown. The sentence will be shown in all cases, whether the Length=6 or Length=10.

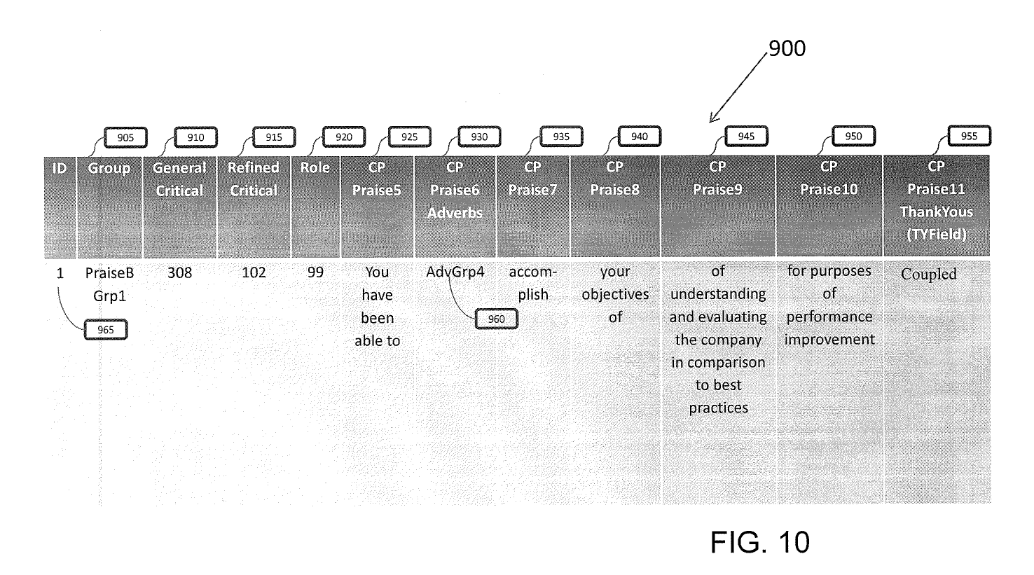

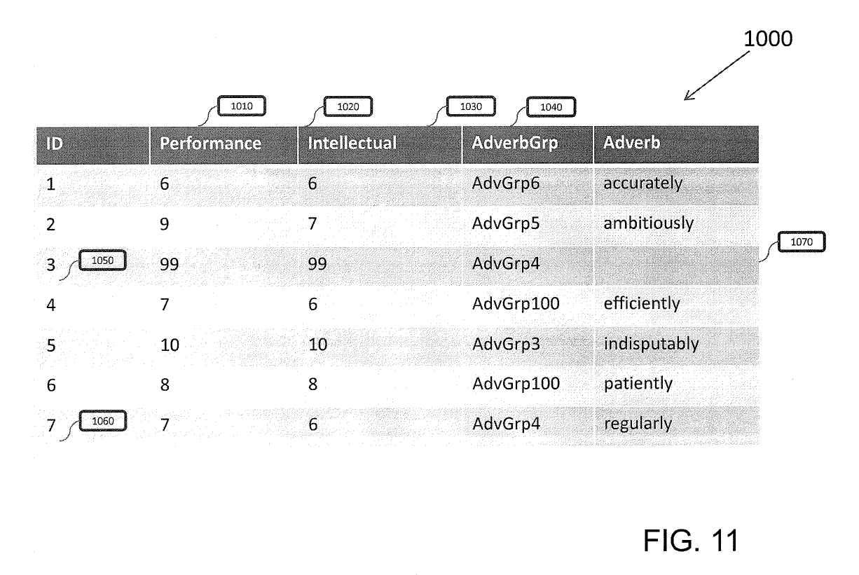

The program then creates the PraisesB Segment. The structure for PraisesB Segment is shown in the table 900 in FIG. 10. In this embodiment, this Segment has a connection to both portions of the Critical Inputs, columns 910, 915. This is because this portion of the Communication is intended to provide the Receiver with specific comments about a particular thing that they did a good job with (the Refined Critical). In other embodiments, it is possible to have a segment connected to the Refined Critical variable and not the General Critical variable. The Table 900 shows only one record of the table to simplify the example. However, there will be many records in this table. Five text Fragments are identified in columns 925, 935, 940, 945, 950 as well as two special-purpose fields, columns 930, 955. The first special-purpose field column 930 is CPPraise6. To determine what will be included in the CPPraise6 field, the “Adverbs” Table 1000 in FIG. 11 is reviewed to match to AdvGrp4 cell 960.

The Adverbs Table 1000 FIG. 11 follows the same rules as applied to the above tables. The “Adverbs” table 1000 is reviewed to identify a match with variables identified there as compared to the users' inputs and/or variables identified in the PraisesB table. First, the Group from cell 960 of the PraisesB Table 900 is matched with the Group AdvGrp4 column 1040 in the Adverbs Table 1000. In this circumstance, there are two matches, records 1050 and 1060. Then other variables of this table are matched. In this case, the record identified as matching the record 1050 also matches with the other two Ratings of Performance Column 1010 and Intellectual column 1020 due to the use of wildcards 99 in the table 1000. The second record 1060 matching the AdvGrp4 also matches the Ratings for Performance=7 and Intellectual=6 originally input by the user. In this example, ID #3 is randomly chosen. Because the text Fragment 1070 is a blank, an adverb is not added to this Segment created at the table 900.

CPPraise11 column 955 table 900 is treated differently, as it has already been identified and does not require further matching. This ThankYou uses the same table as the first ThankYou. Recall in the PraisesA Segment the following fields were chosen:

Option 1 ThankYou field: “We appreciate you”. ThankYouFor field: “We want to personally thank you for”

Option 2 ThankYou field: “We appreciate you”. ThankYouFor field: “We appreciate you for”

CPPraise11 is populated by the ThankYou field of “We appreciate you.” as both options provide the same result in this example.

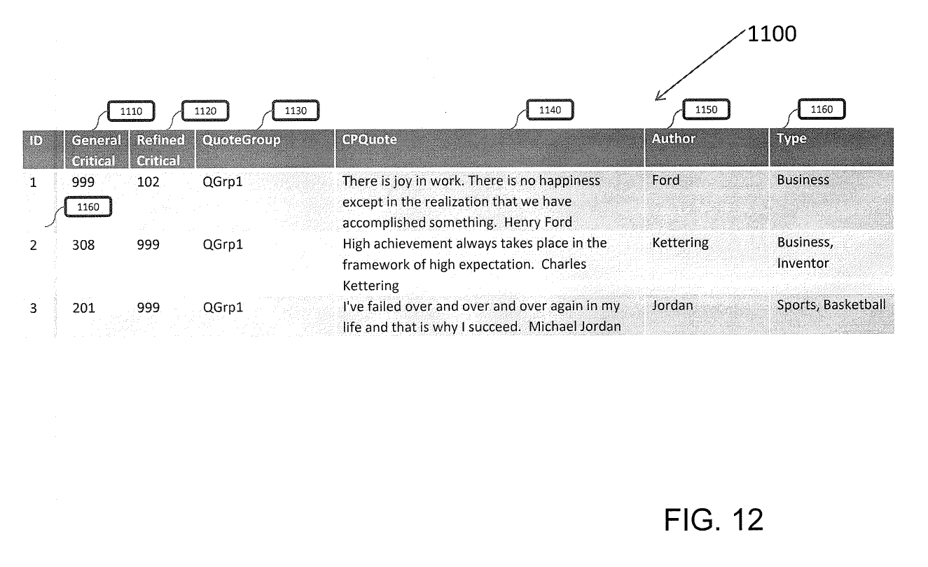

To determine what will be included in the Quotes segment, the program reviews a “Quotes” Table 1100 in FIG. 12. The QuoteGroup column 1130 containing QGrpl is considered because of the entry in cell 365 of the master groups table 300 because the General Critical and Refined Critical from the Inputs match with the table 1100. ID #1 and ID #2 are identified as potential Quotes because one of the Quotes column 1140 of the matching records is to be included in the Quotes Segment. The table 1100 also includes additional pieces of information columns 1150, 1160, such as the author's name and type of quote, for example. Information such as this is saved in the database 112 to allow for future Communications to choose a favorite author, or a favorite type of author of the Receiver of the Communication. Other additional fields may be offered, which would be matches to the Communication receiver's preferences/profile as opposed to the user's Inputs. In this example, ID#2 was randomly chosen.

The program takes each of the five Segments mentioned above, and combines them into a Communication. The segments are filtered for length as described above. If greater than one complete Communication is generated, one will be picked randomly, or based upon priorities. Not all Communication will have the exact structure identified above; this is for example purposes only.

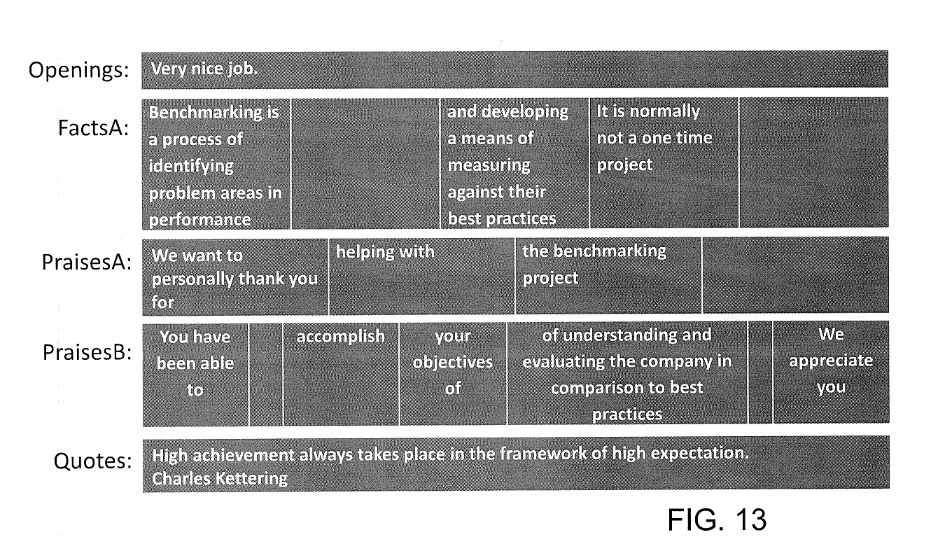

In summary, Input of 308, 102 with Ratings of Length=8, Performance=7, Intelligence=6, Thinking vs. Feeling=6, Individual vs. Team=7, Role=6, and Boss=6 returns the Communication shown in FIG. 13.

The above embodiment as a compilation of text fragments is not intended to limit the invention to feedback in the workplace environment or to textual communication. Other embodiments include additional tables that reference other media, such as cartoon strips. Children or others using this embodiment may choose characters looking like themselves. They may then, for example, receive Communication from their basketball coach. The text Communication is compiled, as explained above, and is then combined with the cartoon strip. Their Communication may be along the lines of “Great game Jacob, you made three baskets.” And the basketball cartoon strip will show the character Jacob, making a basket. The tables will reference coding for predrawn cartoon strips in the same fashion as was described, for example using General Critical, Refined Critical, Input Variables, Groups, and Dependent Groups. Other embodiments become obvious such as incorporating animation and or sound. The invention relates to the process, and is expected to generate many different forms of Communication (or text/data/media selection) using varied media as Fragments.

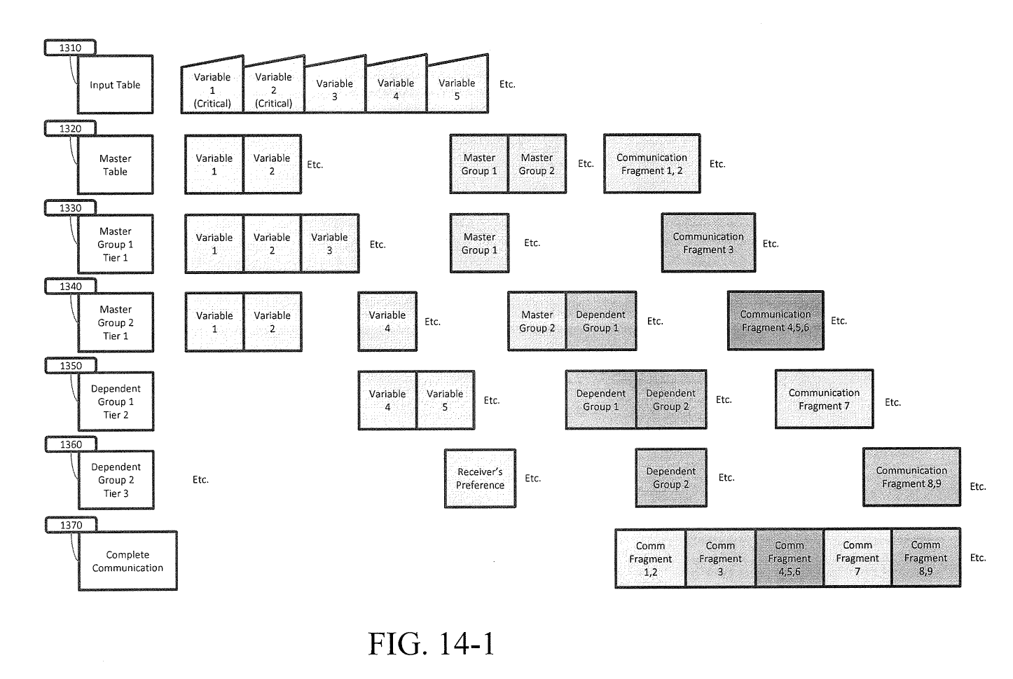

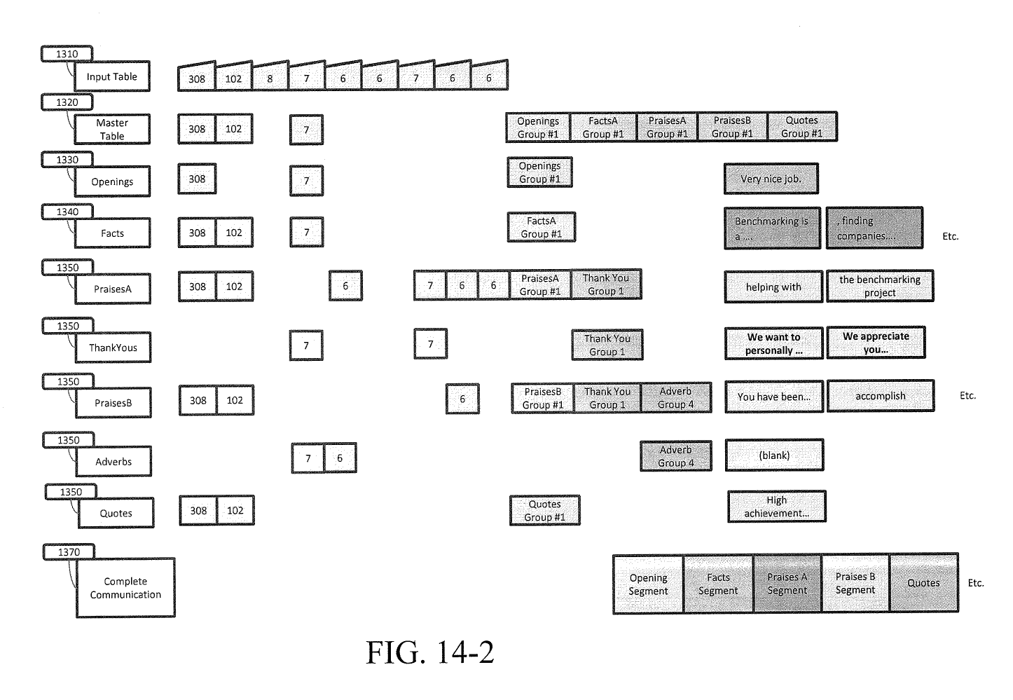

FIG. 14-1 is a diagram of the relationships between tables and fields. An Input Table 1310 includes fields that are input by the user, based upon predefined ranges or choices. In this example, the first two inputs are Critical Inputs (meaning they are needed to define a record in the Master Table) the other three are Inputs that may or may not be utilized in the creation of the ultimate Communication.

Each Master Table 1320 provides the structure to the Communication. There may be multiple Master Tables. In this example, the Master Table 1320 has identified a record (Master Record), matching the two Critical Inputs, which has two Master Groups. The Master Record also has one Communication Fragment. The Communication Fragment is part of the final Communication (before considering filtering for length). The two Master Groups are used to identify Master Group Tables which contain records which may have Communication Fragments, or additional Groups, all with the purpose of identifying Communication Fragments to create a Complete Communication.

A Master Group 1 (Tier 1) Table 1330 is the table created for a Group that is a field in the Master Table. Any Tier 1 table matches its Group name directly with the Group name in the Master Table. In this example, the Master Group (Tier 1) Table 1330 is matching two Critical Inputs, one additional Input with the Input Table, and one Group from the Master Table. To the extent a record in this table matches all four of these criteria, the Communication Fragment will be offered to be a part of the final total Communication (before consideration of filtering for length).

A Master Group 2 (Tier 1) Table 1340 is almost identical to the Master Group 1 Table 1330, with the exception that instead of just matching to predefined criteria, the table is creating an additional criterion of its own. The Master Group 2 Table 1340 is referring to the Dependent Group 1. It provides an identifier for this new group. This Group also provides three Communication Fragments for the final Communication.

A Dependent Group 1 (Tier 2) Table 1350 is the first example in this diagram of a Tier 2 Group. It is dependent on the Tier 1 table identifying its Group name, rather than the Master Table. In addition to having the Group identifier match the Tier 1 table, it also matches with two noncritical variables from the Input Table 1310. It could have as easily matched with a critical variable from the Input Table. This table will provide one Communication Fragment for the final Communication.

A Dependent Group 2 (Tier 3) Table 1360 is intended to show that this process can be repeated, and another dependent Group can be added, creating a third Tier. This tier would be dependent upon the Tier 2 Group. This is also an example of matching with the receiver of the Communication's personal preferences or profile information, as that match is required to identify a record from this table. This table will provide two Communication Fragments for the final Communication.

FIG. 14-2 shows the same diagram as FIG. 14-1 except filled in using the example shown in FIGS. 3 through 13.

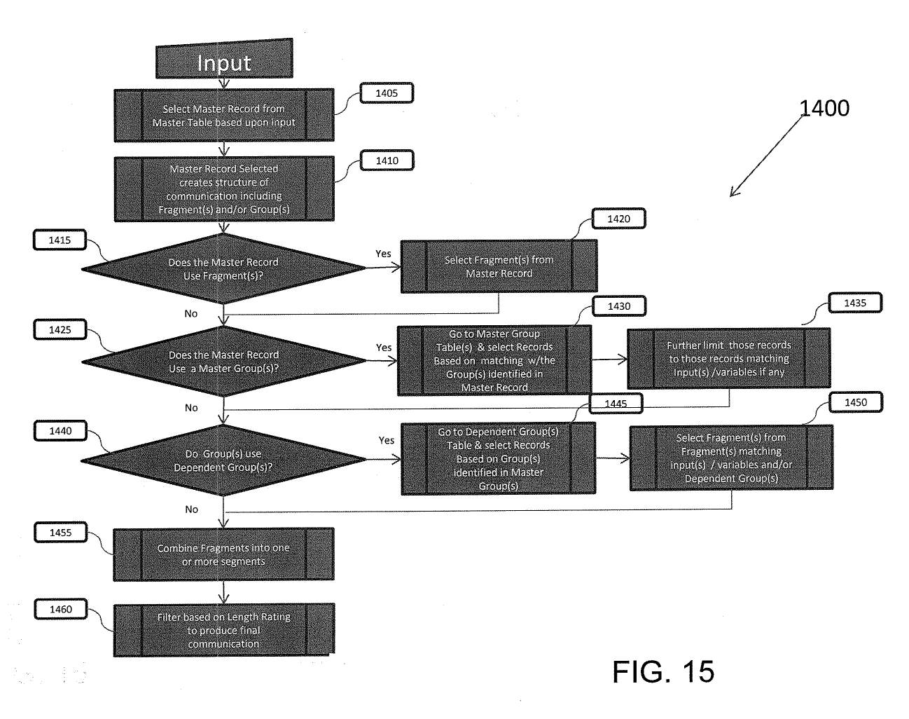

The final Communication 1370 takes the Communication Fragments from each table, and combines them together to form a total Communication. FIG. 15 shows when a process 1400 will filter the Communication for the Length Rating.

FIG. 15 shows the process 1400 as described above in a flowchart format. At a block 1405 the Master Record is selected from the Master Table based upon User Input. User Input may include Critical input(s), and noncritical input(s). In this embodiment the Master Table identifies the Communication structure block 1410. The Communication structure in the Master Record chosen may identify Communication fragments at decision block 1415 immediately, and these Communication fragments may be selected at block 1420 and combined to form a Communication at block 1455, filtered for length purposes at block 1460. More commonly the Communication structure in the Master Record will have fields that will identify Groups at decision block 1425. These Groups will refer to another table at block 1430, where first the Group name will be matched with records in that table. In addition to matching with the Group name, the records may also have other variables which can be matched to such as User Inputs and/or preference or profile information of a user/receiver at block 1435. These records, or Communication Fragments may be selected and combined to form the Communication, and filtered for length. Instead of going directly to creating the Communication, the tables may have additional Groups which also need to be matched to other tables containing Fragments. These Groups may be dependent on the Critical Inputs or other variables, or they may be only matching items in a previously defined Group. In this case, they will be referred to as Dependent Groups at decision block 1440. The Dependent Group will identify an additional table, and this table will match the Dependent Group Name in the previous table with the Dependent Group Name in the Dependent table, creating a set of records at block 1445 which are appropriate for the Communication. These records may have additional variables which will be matched, further limiting the records that are acceptable in the Communication at block 1450. These records, or Communication Fragments may be selected and combined to form a Communication and filtered for length.

Next, the invention is discussed with respect to an embodiment as an empirical database, which is reliant on the invention as an embodiment of a process of combining communication fragments, discussed above. This form of the invention is discussed as the empirical database relates to the text fragment discussion above. However, it would also apply to other embodiments of the invention of combining data, other than limiting the empirical database to text fragments. It is presented in this fashion for example purposes only.

As Communication is received, the feelings, productivity, morale, etc. of the Receiver may have been changed; hopefully in a positive or satisfactory manner. The ability to understand if the change was positive or satisfactory would be very valuable to the Sender. The invention embodied as a system of creating an empirical database begins upon the sending of a Communication. The purpose of this embodiment of the invention is to measure the effect Communication has on a Receiver in order to predict how future Communication will affect receivers. When a Communication is received, the Receiver has the option to complete a survey (mandatory in certain embodiments). The empirical database aggregates all responses to the surveys of a particular Communication or type of Communication and creates statistics identifying which Communications have the most positive or satisfactory effect on specific classifications of people. It is determined which Communication on a particular topic will be the best Communication to be used by a particular sender (understanding their preferences and personal information) to a particular Receiver (understanding their preferences and personal information). In certain cases, if the surveys were hidden data it would encourage honesty in responses from the Receiver. In certain embodiments, the survey responses from the Receiver are hidden and not shared with the Sender of the Communication. The survey's purpose is to allow the empirical database to become intelligent to enable it to provide good recommendations in the future. The survey's purpose is not to provide feedback to the sender. The hidden nature of the survey allows for greater honesty in responses.

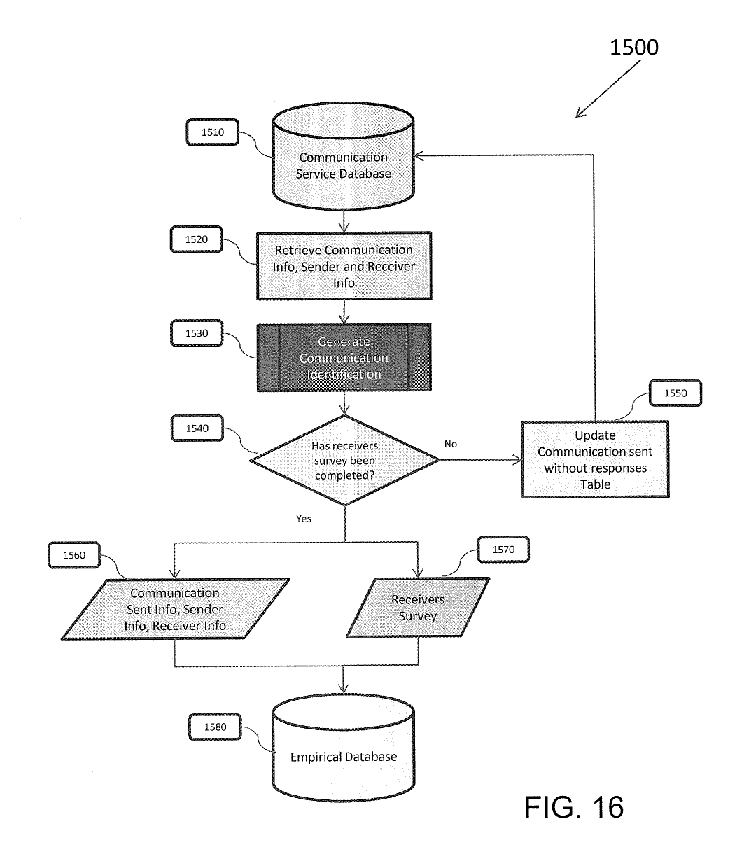

FIG. 16 shows a process 1500 for saving Communication survey responses to create an Empirical Database. A Communication is identified and saved. The communication includes but is not limited to pertinent information about the Communication block 1560 (the personal information, preferences and statistics of the Sender and Receiver) and the responses from the Receiver's Survey at block 1570. The personal information and preferences of both the Sender and Receiver are identified at the time the Communication is being sent as this information will be dynamic and should be captured for that moment in time. When the Communication service is being used (discussed further below), the Communication is retrieved from the Communication service database 1510. This information, an example which is described in detail below, is saved into the Empirical Database at block 1580.

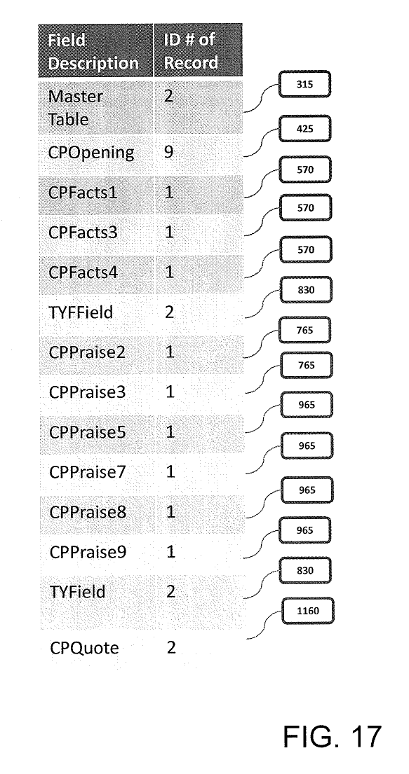

In order to save a Communication, it must be associated with an identifier. The Communication system may have multiple ways of referring to it. In the above example, the user's inputs were “308, 102, 8, 7, 6, 6, 7, 6, 6” and the Communication could be saved into the empirical database using that identifier. Instead of saving the exact paragraph, it simply saves the user's choices. An alternate way of referring to the Communication would be to save the exact records used by referring to the field name and the ID number in the different tables. First, as explained earlier, the Communication forms its structure from a record in the Master Table or a Group identified by the Master Table. In order to save the Communication in the empirical database in the exact compilation as it was sent, the database must save the Communications' record structure as well as each text fragment. Refer to FIG. 17 for an example. FIG. 17 shows the field description of the table, and the ID of the record ultimately chosen to be in the Communication. In another embodiment it may be saved in both formats. In other embodiments that allow the Communication to be edited by the Sender, the edits or fact that it was edited will be saved as well.

The Communication will be saved into two places: in the Communication service database 1510 with the history for both the Sender and the Receiver, as well as in the Empirical Database 1580. At the time it is sent, it will receive a unique identifier at block 1530, for this example it will be 22000, and the Receiver and Sender's personal information and preferences will be saved with this identifier, referencing their user names or identifier. The number 22000 and its related information (without the Receiver's response information) remains at block 1550 until the Receiver responds to a survey or the unused history is deleted. When the survey is received, the Communication information 1560 and responses of the survey 1570 are saved into the Empirical Database 1580.

The level of satisfaction will be increased or diminished based upon certain aspects of the Communication. In an embodiment for Workplace Feedback, each employee may need different amounts of feedback to maintain the highest morale and performance (two measures chosen for example purposes) he is able to achieve. One employee may need to receive different amounts of Communication based upon who is sending it to him. For example, amounts will differ based upon the amount of respect the Receiver has for a particular Sender, as well as if he trusts that the Sender is capable of providing quality feedback. Only that employee will know the true amount by different work relationships. Because of this complexity, the empirical database will need to track different variables.

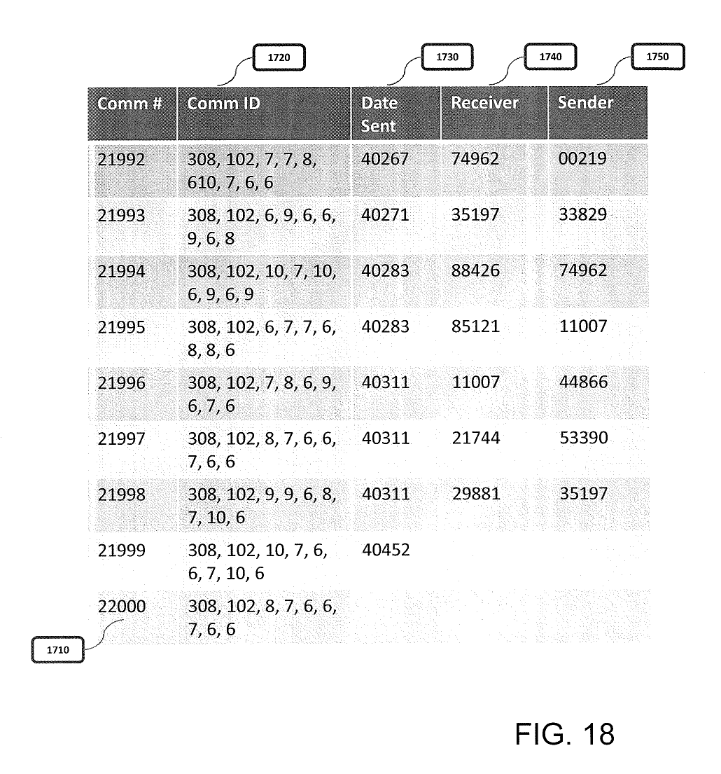

FIG. 18 shows the Communication item 1710, with the Communication variables chosen column 1720, date sent column 1730, Receiver column 1740, and Sender column 1750. The date is stored in a value format that can be recognized and converted to and from the date format to enable it to be used in formulas calculating the elapsing of time.

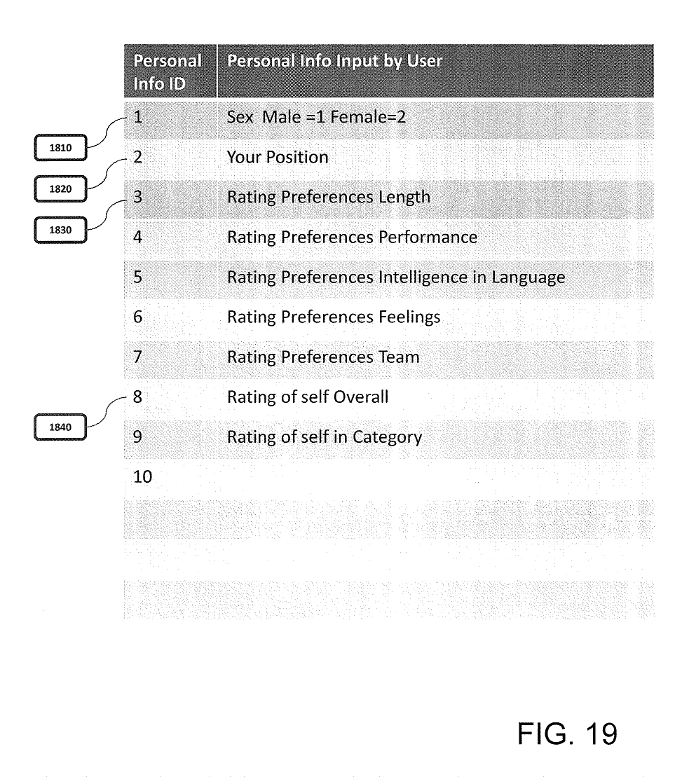

FIG. 19 shows an example of types of personal information and preferences. This embodiment identifies Personal Information ID #1 through 10, including the sex of the user item 1810, the position in the company (the low end of the scale being a new hire and the top end of the scale being the executive management) item 1820, as well as Rating preferences of the variables item 1830, and Ratings of self item 1840. The type of personal information and preferences will vary over time as certain items are deemed to have little predictive value are removed and additional items with deemed higher predictive value are added. When certain profile or preference information is used to create the Communication, it will be included in this table as well.

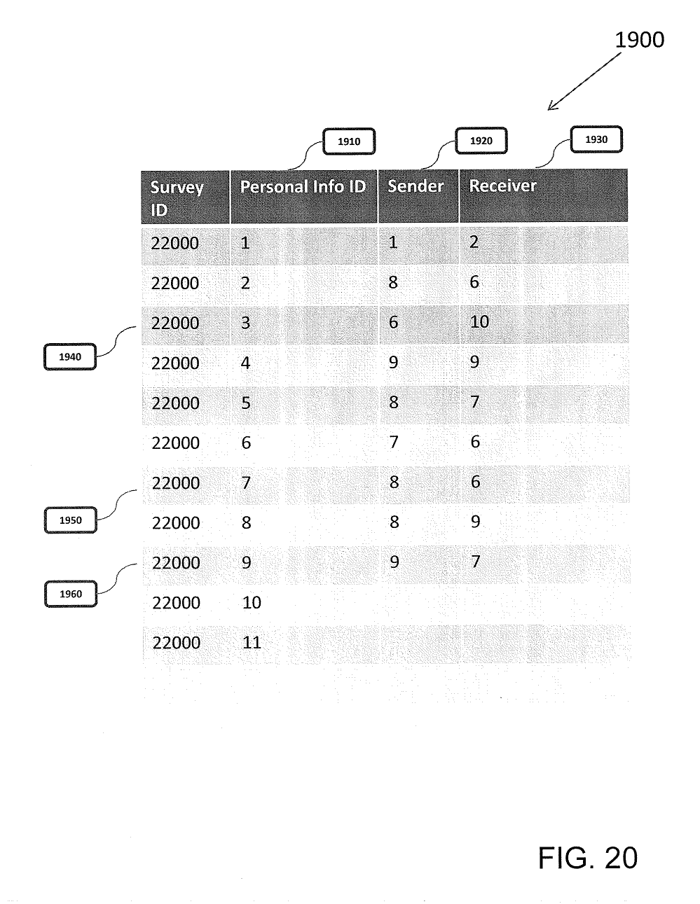

FIG. 20 provides an example of a table 1900 where the Personal Information ID #s (from FIG. 19) column 1910 are used along with the related data retrieved from the Communication database of both the Sender column 1920 and Receiver column 1930. For example, this table identifies that the Sender has a Rating Preference associated to Length of Communication equal to a six, row 1940 (since this is the low end of the scale, it indicates a preference for the shortest of Communications). The Receiver, however, has a preference of 10 (since this is the top end of the scale, it indicates a preference for the longest of Communications). If the empirical database identifies the Length of the Communication has a variable that has a high predictive value for satisfying the Receiver, the Sender's natural choice for Communication may never satisfy the Receiver. In addition, one is able to observe that the Personal Information ID #7, or The Rating Preference of Team row 1950 differs by two for these individuals. The Receiver has a Communication Preference for Team of 6. This indicates she would prefer Communication sent to speak as it has come directly from the Sender (such as “I appreciate you”). The Sender has a Preference for Team of 8. This means the Sender will naturally send Communication referring more to a team (such as “the Team appreciates you”). For the Sender to fully satisfy the Receiver, he may need to change his natural preference for this Rating. The remaining Ratings are within one value of each other with the exception of Rating of Self In Category row 1960, Personal Information #9. This Rating also has a separation of two. The Sender rates himself as a nine (he feels that he is a high performer in this category) while the Receiver rates herself as a 7 (she feels that she is doing a bit better than just “good”). Looking further into the information, Personal Information #2 explains that the Sender is a Rating of eight for Position in the Company (on the high end of the scale indicates this is a senior executive) and the Receiver is a six (indicating a new hire). Combining these two variables explains to us that a Senior Executive of the Company is providing feedback to a new hire, in an area where he feels he is a high performer. Without knowing much else about these two co-workers, one would assume that this feedback will be appreciated by the Receiver because a new employee would like to get positive feedback from someone in the Company with relevant experience in this area. Consider how the feedback might be received differently if instead of a senior executive, the Sender was a seven (meaning slightly experienced) also consider that the Sender considered himself as a six for Rating of Self in this Category, and the Receiver (new hire) considered herself a ten. The Communication might not make as much of an impact. In a situation where a boss is sending a communication to an individual is slightly a subordinate, where the subordinate is a higher performer in the area, the communication that would be motivating may be limited. The empirical database would bring value to these situations, and to many others as will become obvious.

In addition to saving personal information and preferences into the empirical database, a record will also be calculated for certain statistics and saved into the empirical database. In one embodiment, the date value from the current Communication will be compared to the date value of the last Communication that this Receiver received from this Sender. The difference, or number of days between the sending of Communications, is saved as a statistic. Other statistics, such as the number of days between sending of Communications, can be updated each time to create a statistic of, for example, the Prior Average Number of days between this Sender sending Communication to this Receiver, as well as the Average Number of Days between Communications from all Senders providing Communication to this Receiver.

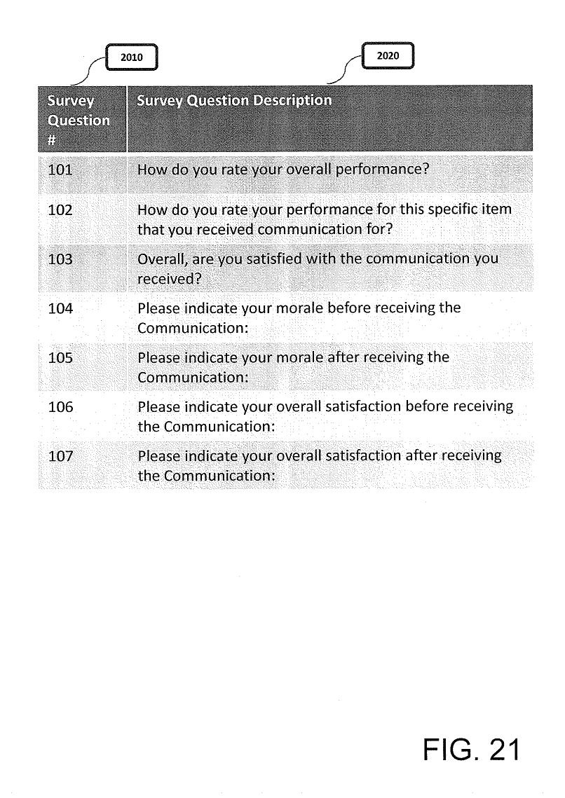

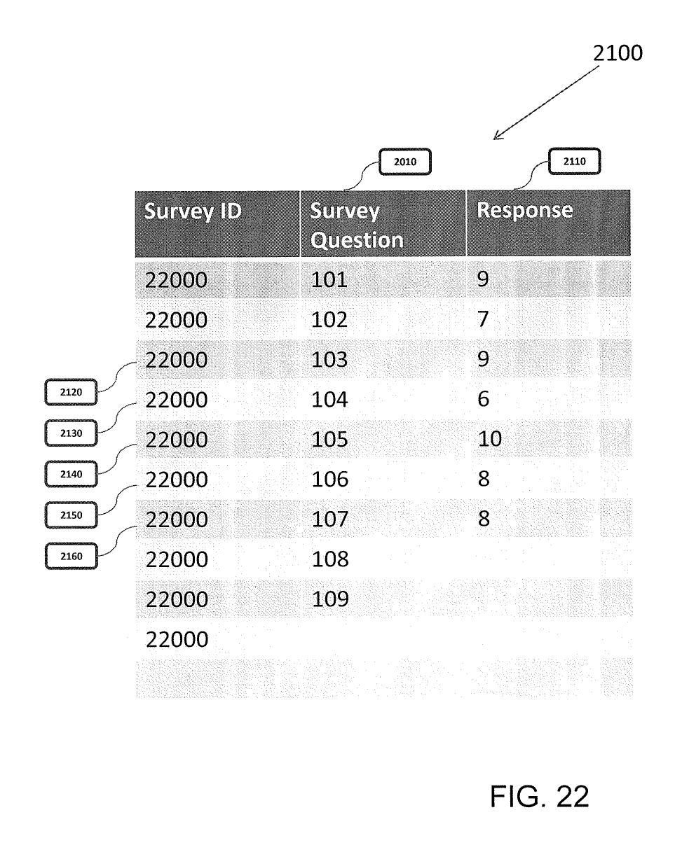

In an embodiment, FIG. 21 is a sample of a Receiver's Survey questions 1 through 7. FIG. 22 is a sample data table 2100 of responses column 2110 from the Receiver's Survey Questions 2010. From these two tables, one can see that the Receiver was highly satisfied with the Communication 2120 (with ten being the highest, this Communication was rated a nine). And that his morale went from a six, row 2130 to a ten, row 2140. This is the highest amount of improvement that can happen on this scale for a Communication. Looking to another question, we see that overall satisfaction was an eight, row 2150, and remained an eight, row 2160. One may conclude by looking at this table alone that a Sender wishing to improve the morale of a Receiver would succeed at that if they sent this exact Communication. However, many other factors are in play as described above.

As the empirical database develops, it will become evident if certain Communication satisfies the Receiver more than other Communication. For example, for Communication related to the Workplace, survey questions are asked relating to morale, job satisfaction and productivity both before and after receiving the Communication as measured by the Receiver. Other areas of Communication will measure different aspects. For the Workplace Communication, the increase in response to question 5 over question 4 will indicate an increase in morale. The larger the difference between the two questions, the greater the increase. The same relationship exists between question 7 and 6, for overall satisfaction. As the database history grows, the purpose will be to use the empirical database as a predictor to determine which Communication to send to an individual to achieve the highest satisfaction.

To analyze the data, recognize patterns, and recommend certain Communication to a particular Receiver from a particular Sender, the program employs a correlation program to perform data mining and statistical analysis. SPSS PASW Modeler, RapidMiner, and SAS are the most widely used programs currently. These would be examples of the tool to be used for the prediction of which Communication will satisfy the Receiver the most. Linear regression is an example of regression analysis where a relationship is modeled using a variable y with one or more variable x. The data would be modeled on an x-y axis and the unknown parameters are predicted from this data.

In one embodiment, the Receiver would first be placed into groups such as 1) a Receiver who has less than five Communications from the Sender; 2) a Receiver who has an ability to improve satisfaction significantly (average or weighted satisfaction level is less than 8 on a scale of 6-10); 3) a Receiver who is generally satisfied (average or weighted satisfaction level is an 8); and 4) a Receiver who regularly shows significant satisfaction with Communication (average or weighted satisfaction level is a 9 or 10). These groups will change over time as the empirical database grows and other groups are determined to be more predictive. In other embodiments, the Sender may select a type of Group to place the Receiver in, such as a Group that derives the most improvement in Productivity.

In an embodiment of the invention, using the group of Receivers who have an ability to improve satisfaction significantly, the Sender would identify the category of Communication to send, following the example above, 308 102. This particular identifier would also need the Ratings to enable the system to compile a complete paragraph. The program looks to the correlation program to determine which Ratings would create a Communication most likely to satisfy the Receiver. In our example, the Rating the Receiver prefers are: 10, 9, 7, 6, 6, etc. The correlation program would also get the personal information and preferences from both the user and the Sender. This information may indicate that this Receiver prefers Communication in this area (308 102) on a biweekly basis. Once this information is gathered, the correlation program predicts the Communication that would satisfy the Receiver the most using what is deemed to be the most predictive measures of satisfaction. Some measures of satisfaction would extend to various Communication Groups that receivers participate in, which for example may include support groups, religious groups or community service groups.

In another embodiment, instead of having the Sender chose the category of Communication to send (for example, 308 102) the program sends an email to the potential Sender recommending Communication that they believe would most satisfy the Receiver. The empirical database tracks, as one of the predictors, whether the Sender is sending the Communications to the Receiver as they are recommended.

Next, the invention is discussed with respect to an embodiment as a Communication Service, which is reliant on the invention as an embodiment of a process of combining communication fragments, and the embodiment of an empirical database discussed above. This form of the invention is discussed as the Communication Service relates to the text fragment example discussion above. However, it would also apply to other embodiments of the invention of combining data, other than limiting the Communication Service to text fragments. It is presented in this fashion for example purposes only.

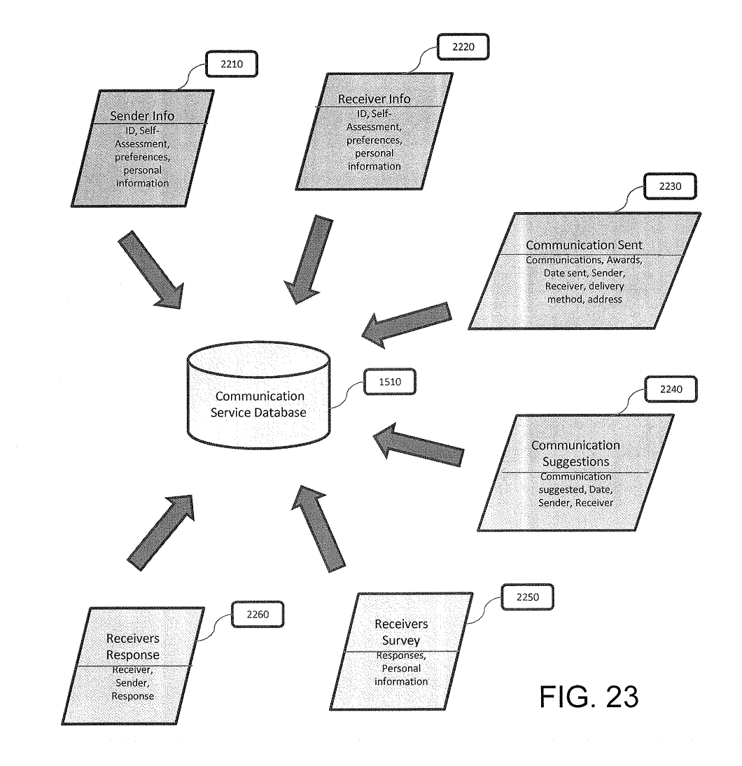

The Communication Service has static and dynamic data. The data tables that store the fragments to be combined into Communications will not be editable by users, and will be considered as static (although updated by administrators). The dynamic portion of the Communication Service relates to the Social Networking aspect, the sending and receiving of Communications, and the suggestions from the Empirical Database. The dynamic portion of the Communication Service receives data from user inputs for variables; responses; surveys; social networking information, such as profiles, preferences and the like; Communications sent by a user; and Communications suggested by an empirical database. The Communication Service database has data tables as described in the invention embodied as a process for combining text fragments, including Master Tables, Master Group Tables, Dependent Group Tables, and Fragment Tables. In one embodiment, FIG. 23 identifies six origins of data flowing into the tables in the Communication Service Database 1510. The data includes Sender Information 2210, Receiver Information 2220, Communication Sent History 2230, Communication Suggestions History 2240, Receiver's Responses to Sender 2250, and Receiver's Survey Responses 2260. The discussion below will provide additional details about each type of data.

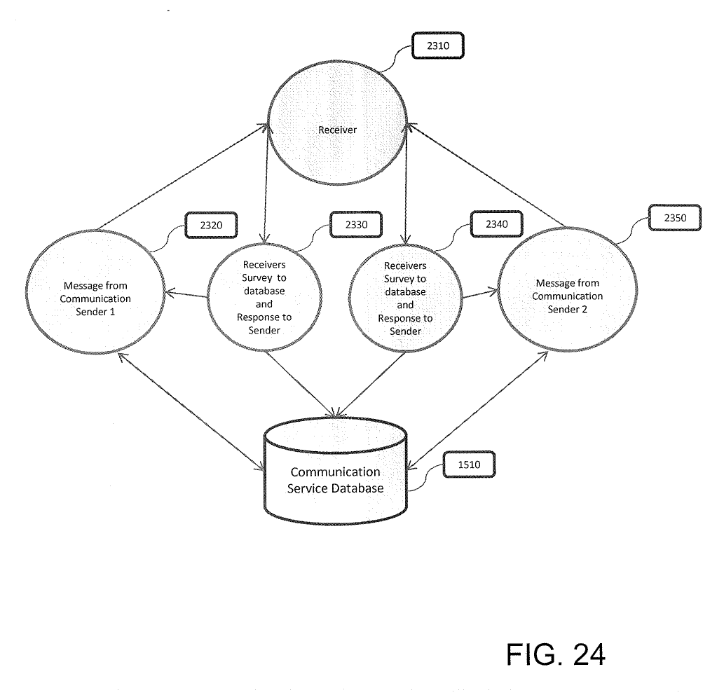

FIG. 24 shows a dataflow process 2300 of Communications and surveys to a Receiver 2310 (device 110). The embodiment of the invention shows one Receiver receiving two Communications. Communication Sender 1 2320 sends a message to the Receiver 2310. After the Receiver 2310 receives the Communication, an option is provided for the Receiver 2310 to send a Response 2330 (e.g., Thank You) to the Sender, as well as complete a survey. In this embodiment, the survey is only used for empirical database purposes and is not shown to the Sender. The Communication Sender 2 2350 performs the same process.

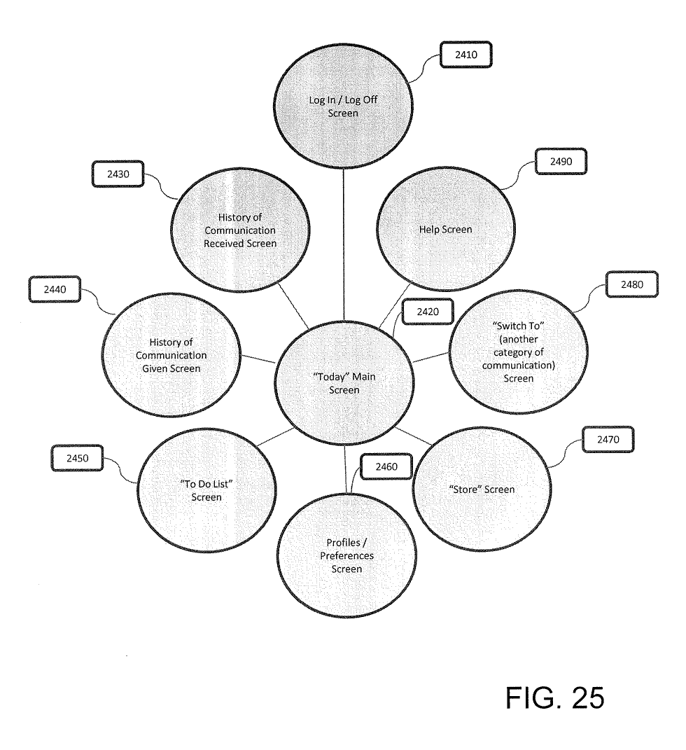

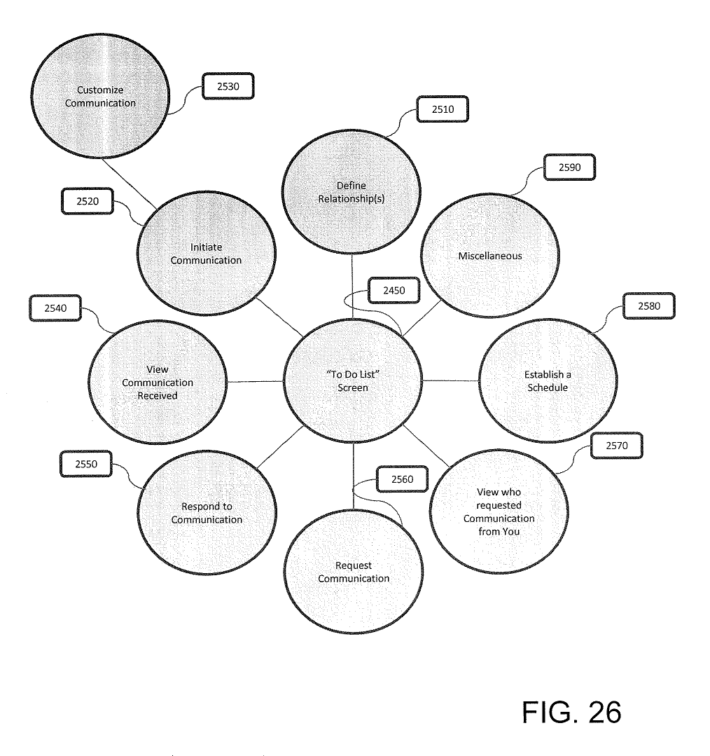

FIG. 25 shows the relationship of the main pages of this embodiment of the Communication Service. A Log In/Log Off page 2410 is the first page seen by users. Other pages, with their brief description are:
Today/Main page 2420—Has a thought for the day and access to Social Network Groups identified by the user. Social Networking Groups will show their messages that were posted to the Group, as well as comments posted for the Group.
History of Communication Received page 2430—Makes available for viewing, printing, or downloading, history of Communication received from others.
History of Communication Given page 2440—Makes available for viewing, printing, or downloading, history of Communication provided to others.
To Do List page 2450—Shows the items that the Communication Service identifies as needing action, discussed further in FIG. 26.
Profiles/Preferences page 2460—Seen only by the user, allows user to enter their Preferences for Ratings, Frequency of Communication, and Relevant dates such as their workplace anniversary or their personal anniversary and birthdate.
Store page 2470—Allows users to purchase items such as hard copies of greeting cards sent, greeting cards received, or hard copies of awards. Items purchased in tangible form will be shipped by the Communication Service.
Switch To page 2480—Switches to another Communication Group such as switching from Workplace Communication to Greeting Cards Communication, to Junior, etc.
Help page 2490—Assists the User with Frequently Asked Questions and provides assistance when problems arise.

These pages are discussed in detail.

FIG. 26 shows the relationship of the To Do List page 2450 to the other pages accessible from the To Do List page 2450. The pages, with their brief description are:
Define Relationships 2510—Identify relationships with other users inside or outside the Social Network, and identify the method the Communication System will use to send the Communication to them.
Initiate Communication 2520—Begin the process of communicating with one of your Relationships, choose the Communication Type, select Critical Criteria.
Customize Communication 2530—After identifying the Communication and Critical Criteria, select Variables, Choices, and manually edit in certain embodiments.
View Communication Received 2540—Review Communication received from others based on different criteria such as date, category, Sender.
Respond to Communication 2550 that you have received—After receiving a Communication, one may respond to the Sender and answer a Survey.
Request Communication 2560—Identify Relationships of who should send Communications.
View who requested Communication from You 2570—View the Relationships that have requested Communication from the user that the user has not yet sent.
Establish a Schedule 2580—For each Relationship, identify a schedule the user would like to send Communication, or ask the Communication Service if there is a recommendation for the scheduling of Communication to certain Relationships. The user may also request a schedule from their Relationships for the frequency of Communication they would like to receive from them. Also, for anonymous Groups, such as drug addiction, request a schedule of Communication from the Communication Service or an anonymous Sender as opposed to one of the user's Relationships.
Miscellaneous 2590—includes functions for users submitting a Communication authored by them or a key word search for Communications.

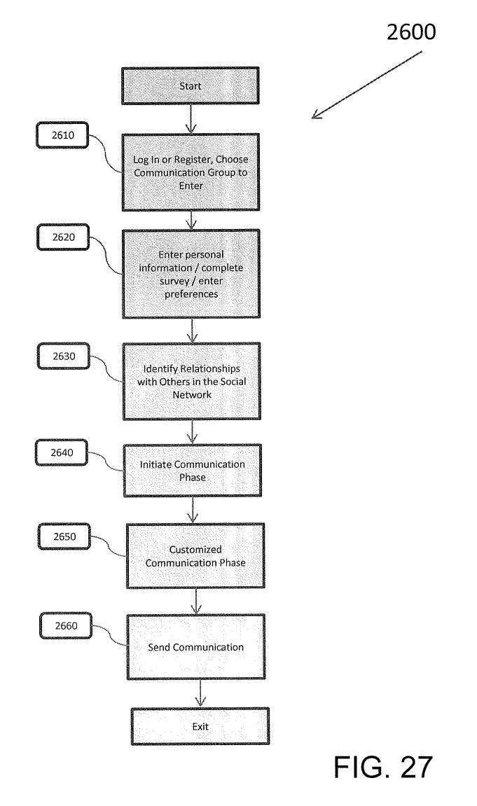

FIG. 27 shows a process 2600 performed by an initial user of the Communication Service from Log-In through the sending of their first Communication. Upon Log-In at block 2610, a user identifies the Communication Group to use in this session. If personal information has not been previously entered, it is entered at this time at block 2620 to enable the Sender to use all of the functionality of the Communication Service. In this embodiment, personal information is optional. However, to send Communication to others, the user must identify Relationships at block 2630 in the next step. After the Relationships are identified, the user initiates the Communication Phase at block 2640. The user enters the Critical Criteria to enable a Communication to be sent. If a more personal message is desired, the user may customize the Communication at block 2650. At that point, the Communication is sent at block 2660.

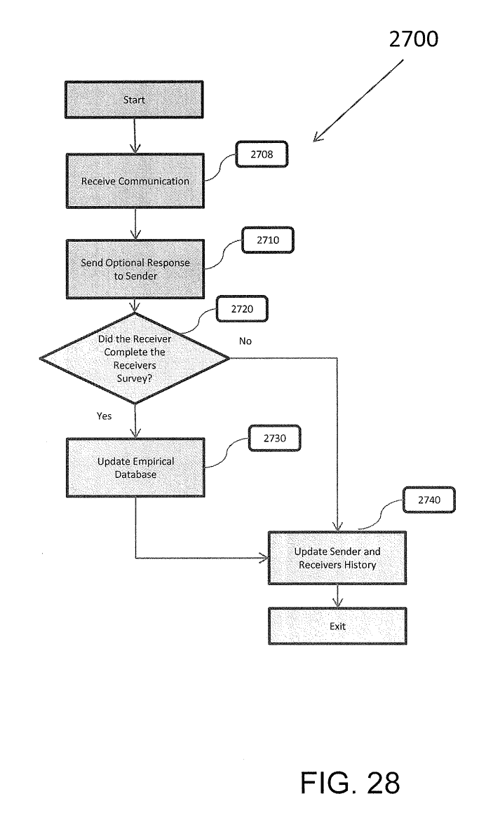

FIG. 28 shows a process 2700 of the Communication Service after a Communication has been sent at block 2660. First the Receiver receives the sent communication at block 2708. Then at block 2710 the Receiver is asked if they would like to send a response to the Sender, such as “Thank You”. This Response is manually written, or in certain embodiments may be generated by selecting variables in the same process as the Communication was created. The Communication Service then at decision block 2720 asks the Receiver to complete a Survey, which will not be shown to the Sender. If the Receiver chooses to respond to this Survey, the Empirical Database described above is updated with the answers to the survey at block 2730, and then the Sender's and Receiver's history is updated with the Communication at block 2740. If the Receiver chooses not to respond to the Survey, the Communication System only updates the Sender's and Receiver's Communication history at block 2740.

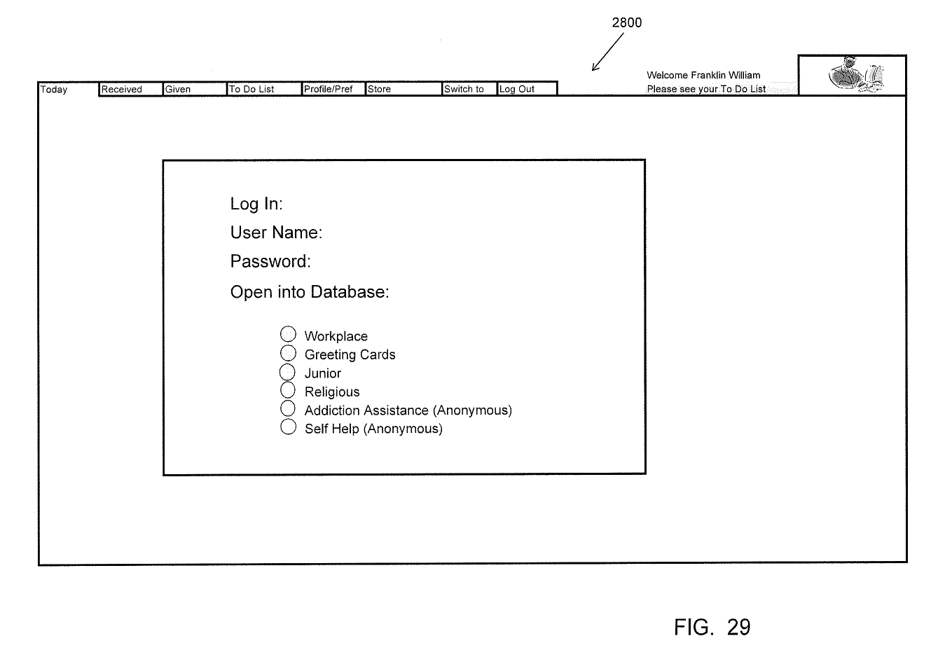

FIGS. 29-39 are exemplary screen shots of pages accessed via user interface tabs of one embodiment of the invention as a Communication Service for Workplace Feedback. They are for example purposes only. The Communication Service is intended to provide many differing types of Communication using multi media. This embodiment focuses on a basic service of compiling text fragments to complete a Communication for Workplace purposes. The Communication Service provides additional features including a Social Network to allow users with similar workplaces or interests to join together, a means of saving history, tracking history, growing an empirical database to provide intelligent recommendations of Communication to users, and a calendar feature to allow automatic reminders of important dates for Communication and scheduling of preferred Communication.

FIG. 29 is the Log-In page 2800 shown upon entering the Communication Service. Similar to websites requiring registration, the service requires a User Name and Password. This page 2800 will identify which Group of Communication to open initially. This can be set as a default in the User Profile and Preferences. Examples of different types of Groups are as follows:
Workplace—the embodiment used as an example in this application.
Greeting Cards—an embodiment which will have a database of prewritten Communication fragments that are combined upon Critical Input, Variables, and Options. General Critical categories may include Holidays, Birthdays, Special Days, Anniversaries, Grief, Sympathy, Get Well, Well Wishes, Thank You, Friendship, Romance, and special categories. Texting, Tweeting, and other methods of spontaneous Communication have created a need for immediate communicating. For example, one category will be Smack. This will allow sports fans watching a game, to send Smack (gentle prodding in a competitive fashion of the expected outcome of a game) to Relationships in the Social Network in a real-time fashion while watching a sports game. The Communication Service would be able to track progress of a game, and Applications (e.g., iPad®, iPhone®) would be able to initiate a Smack Communication, or accept the recommendation of the service to send a Smack Communication. Other real time applications will be used to fill the need of immediate Communication.
Junior—this embodiment is intended for minors. Often parents avoid the use of internet applications for children due to the possibility of bullying. In this embodiment, the message to be sent would not be able to be edited. In other words, only positive Communication can be sent from one minor to another. Groups identified could be school grades, or classes. Other Groups could be related to a church group, a sports team, or for example, an anonymous group for foster children where they can provide positive encouragement to one another without fear of being identified or judged, but with the comfort that the other individual understands the challenges they face. Because in this embodiment only prewritten Communication can be sent, and it is not able to be edited, bullies and internet predators can be restricted from taking advantage of the children.
Religious—this embodiment will provide a database of prewritten messages intended to uplift others within a religious context, including scriptural references and interpretations.
Addiction Assistance—this embodiment is intended to be used for those struggling with addiction. It is anticipated this embodiment will have an optional Anonymous component to it. This would allow those struggling with drugs, alcohol, or other additions, to receive Communication from the Communication Service directed to their challenges. For example, those struggling with drugs may receive a daily message to encourage them to remain drug free. In this embodiment, the Anonymous Receiver may receive messages from celebrities or sports stars explaining that they have faced the same challenges, and offering a suggestion on how to stay on track. In addition, a Receiver may also have a user name that allows others, such as family and friends, to identify them as a Relationship, so they may receive positive encouraging messages from them, as well.

Self-Help—this embodiment is similar to the Addiction Assistance, with a database with a different message. Self-Help message would allow the Receiver to ask the Communication Service to send Anonymous regularly scheduled messages for areas of Self-Help. These areas may include weight control support, improvement in interpersonal relations, encouragement to overcome challenges relating to post-traumatic stress disorder or physical abuse. The database may provide celebrities or sports stars messages much like the Addiction Assistance Group. In addition to receiving Communication automatically from the Communication Service, there may be Anonymous Social Networking Groups such as a Military Group where soldiers returning from combat may anonymously join a group with other soldiers to send and receive supportive encouraging Communication.

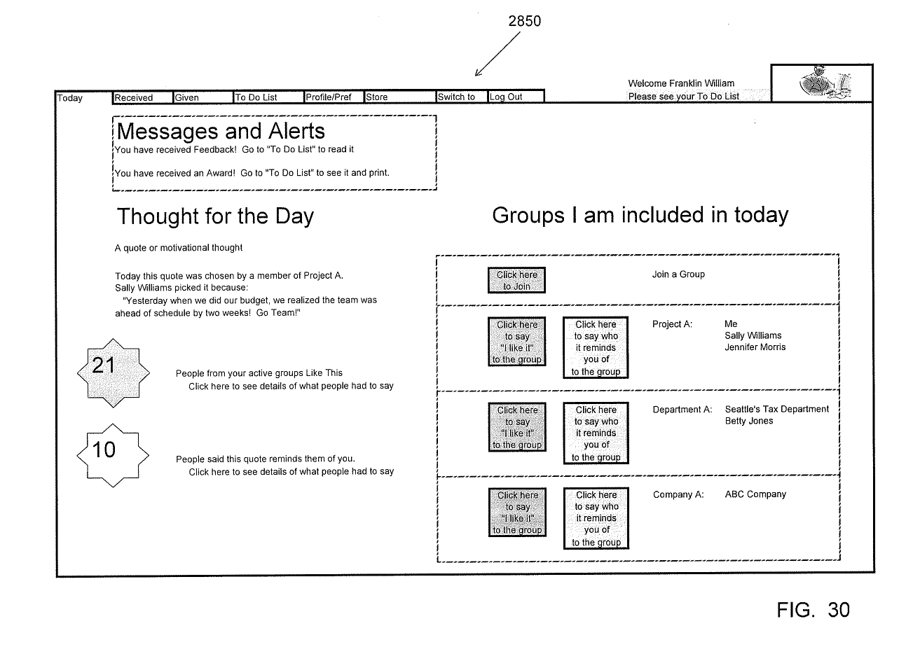

FIG. 30 is a sample screen shot of the Today page 2850. The today page 2850, an embodiment of the Workplace Group, offers notifications if there are unread messages or awards, as well as Groups the user is included in today and the Thought for the Day. The Thought for the Day may be chosen by a Group member and are selected from a database. Participants in the Group may comment if they like the thought, or if it reminds them of an individual in the Group.

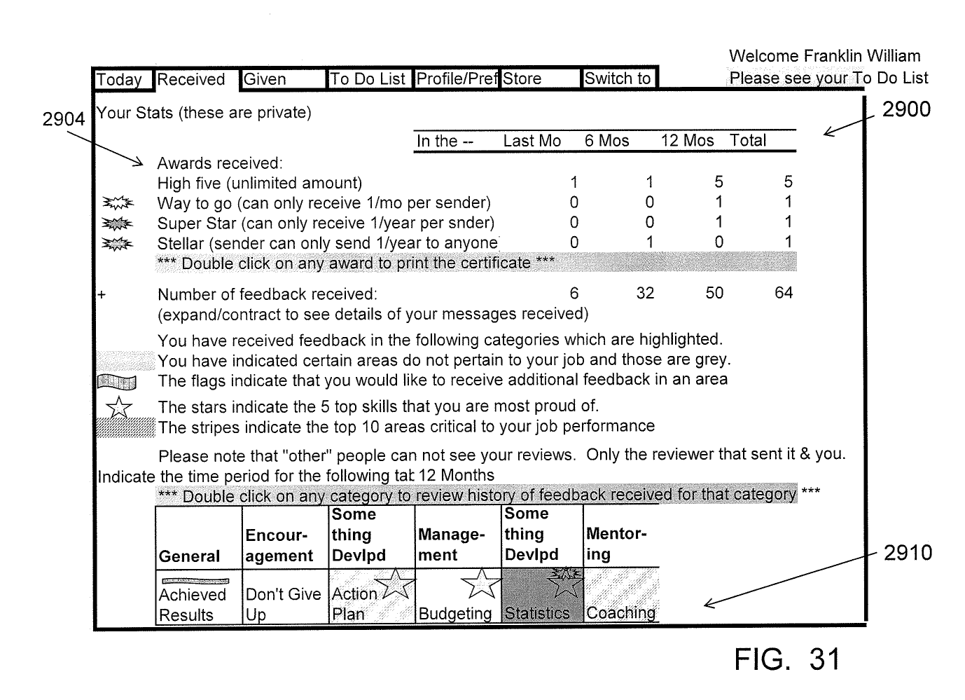

FIG. 31 is a sample screen shot of the Communication Received page 2900, which provides statistics related to the Communication Received, such as the type and date of receipt. The user is able to print out the Awards he has received, as shown in section 2904. This page 2900 also shows what General Critical categories the user has identified as having a special meaning or priority for him. For example, in this embodiment, the user is able to identify General Critical areas that: does not pertain to his job, is an area where he wants additional feedback (which can further be defined as an area where he wants a particular Sender to provide feedback), are included in the top five skills that he is most proud of, and the top ten areas critical to his job performance. As other areas are identified as being more predictive of job satisfaction, these will change. The user can double click on a matrix 2910 to see the information mentioned above associated with that General Critical category. Also, if Communication has been received, the General Critical category will be color coded based upon the average feedback performance Rating. For example, if the average feedback received for Management Skills is Great or equal to a Rating of 8, it will appear on the page 2900 as bright green. The Communication Service allows for a download of the Communication history.

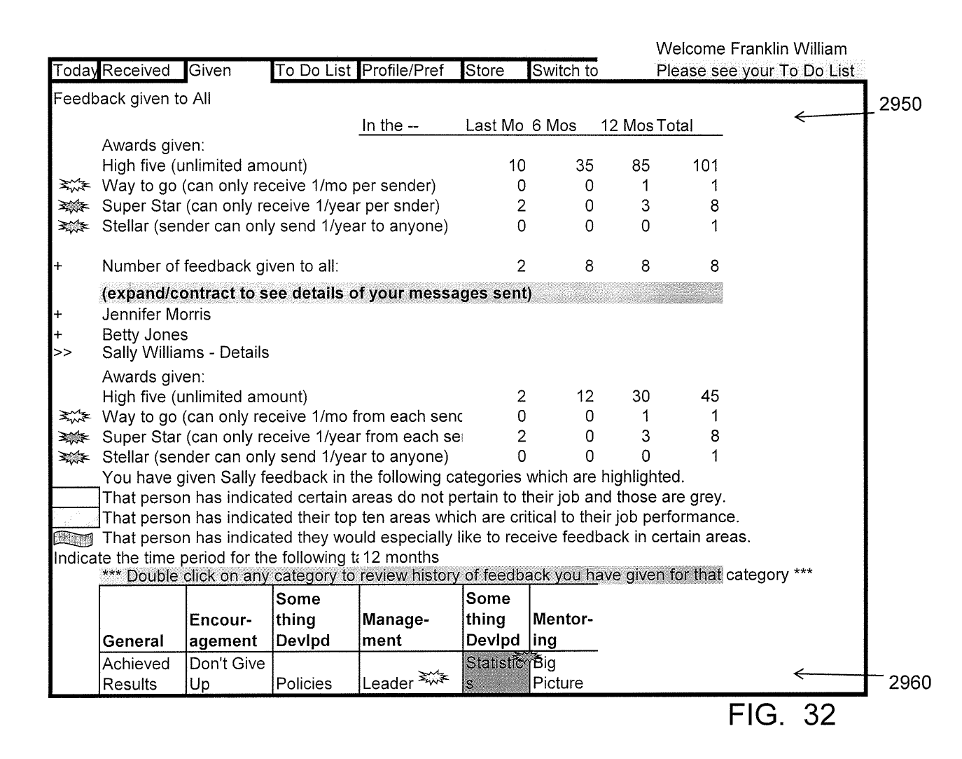

FIG. 32 is a screen shot of a page 2950 of the Communication provided to others. A user can use this page 2950 to review prior Communication given to others. Much like the Communication Received page, it provides a matrix 2960 of the General Critical Categories, and will be provided for each user one provided Communication. In addition to the same information provided in FIG. 31, this page 2950 also provides an indicator by General Critical Category for when the Receiver has requested Communication in a specific area. When that request has been specifically requested of you, it will be blinking Note that the user may only see Communication they provided to the Receiver, not Communication others provided to the Receiver.

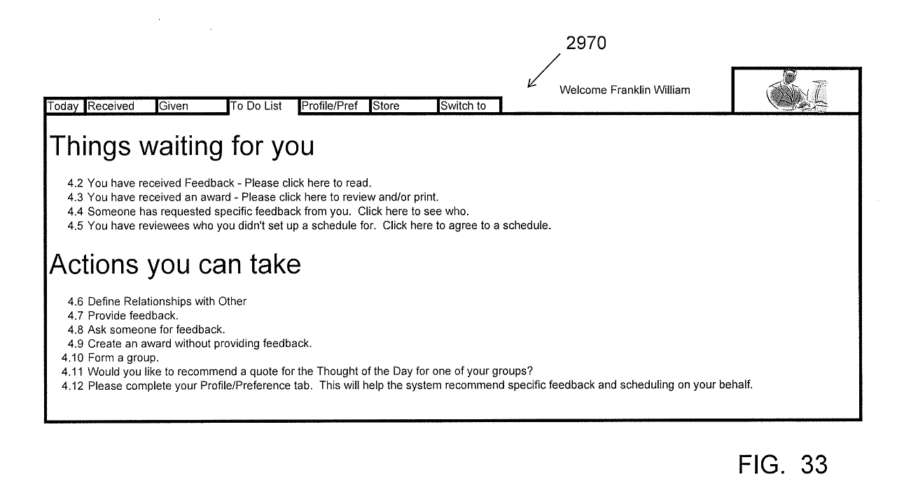

FIG. 33 is a screen shot of the To Do List page 2970, and identifies the following activities:
You have Received Feedback—Someone has sent you a Communication that has not yet been read.
You have Received an Award—There are different levels of Awards. Awards are intended to show a Receiver when they have gone especially above and beyond. There is a general award that is sent with each Communication. In addition, there are other levels of awards. Examples include awards that can only be sent once a month to each Receiver, awards that can only be sent once a year to each Receiver, and awards that can only be sent once a year to any Receiver by that Sender. In this way, a receiver of a Communication can understand that the sender feels their actions are notable. The Receiver can print these awards themselves, or purchase a hard copy through the Communication Service's Store.
Someone Requested Feedback from You—Someone has asked that the sender send a Communication to them, and it has not yet been sent.
You Need to Establish a Schedule—One of the Relationships does not have a frequency schedule established for Communication.
Define Relationships—Setting up those people that the sender expects to receive a Communication, or will be in one of the sender's Social Networking Groups.
Provide Feedback—Send Communication.
Ask for Feedback—Ask for someone to send a Communication to the user.
Create an Award without Providing Feedback—There may be occasions where the user would like to send an award without sending a Communication, and this feature will allow that. An example of this might be a Group award.
Form a Group—Create a group that can send Communications to all, or post Thoughts of the Day for the Group, etc.
Recommend a Quote—The Today page will list a Quote each day. Users of the Communication Service can recommend a quote, and it will be identified as from them.
Complete your Profile/Preferences—This function will identify those items in the profile and preferences that are still open or unanswered.

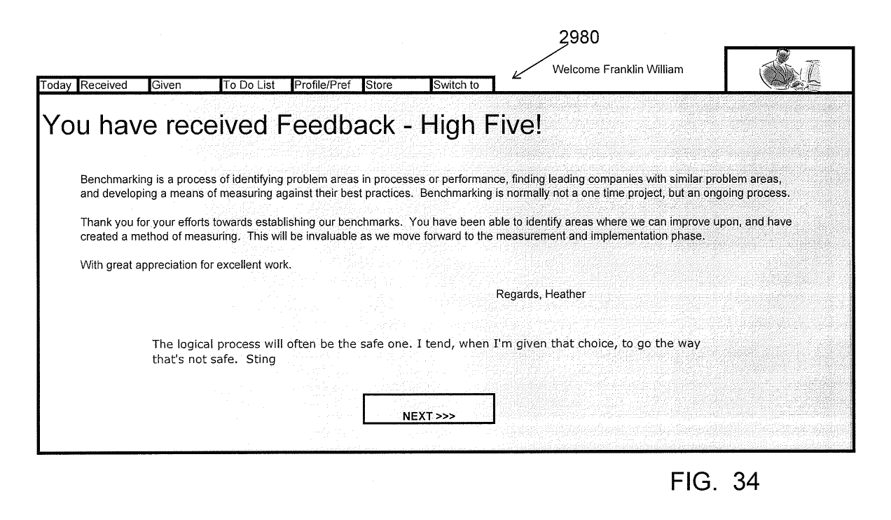

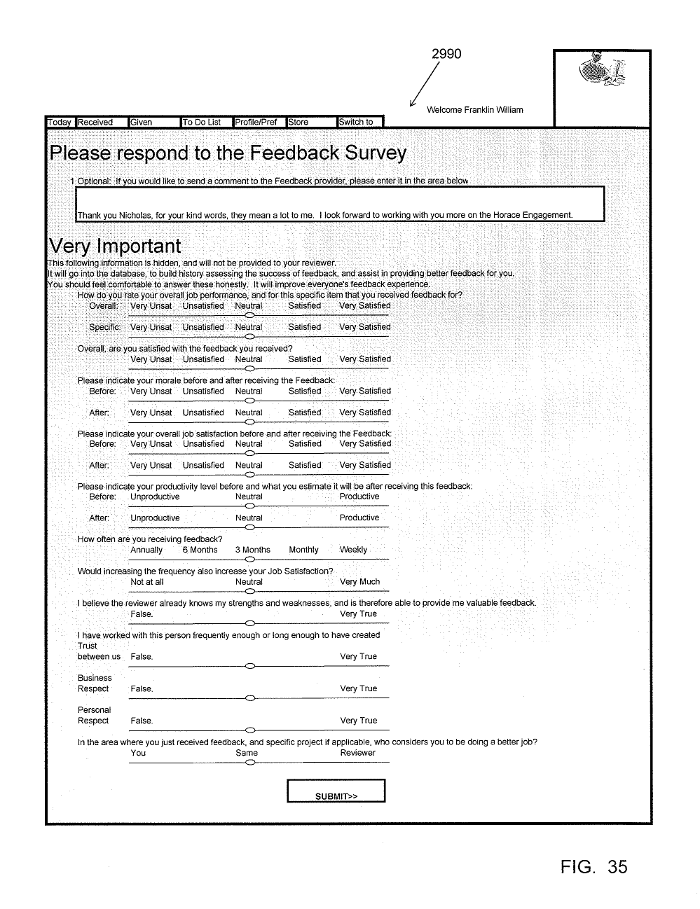

FIG. 34 is a screen shot of a page 2980 that the user sees when they have received Feedback, and is accessed through the You have Received Feedback click through. This page 2980 displays the actual Communication sent, with a Next button to forward the user to the next page FIG. 35.

FIG. 35 is a screen shot of a page 2990 of the Receiver's Response and Survey. This embodiment allows the Receiver to manually respond to the Communication. For example, a user can say “Thank You Nicholas for your kind words, they mean a lot to me. I look forward to working with you more on the Horace Engagement.” This allows the Receiver to personalize their comments. Other embodiments only allow the Receiver's Response to be selected using Ratings and Variables, for example for minors or anonymous users. The Receiver's Survey is shown. The responses available are within a range, which allows the Communication Service to convert most responses into numerical values. For example, the low end of the range equals six, and the high end of the range equals ten. The Receiver is able to respond to some or all of the Survey, and submit the responses to the Communication Service.

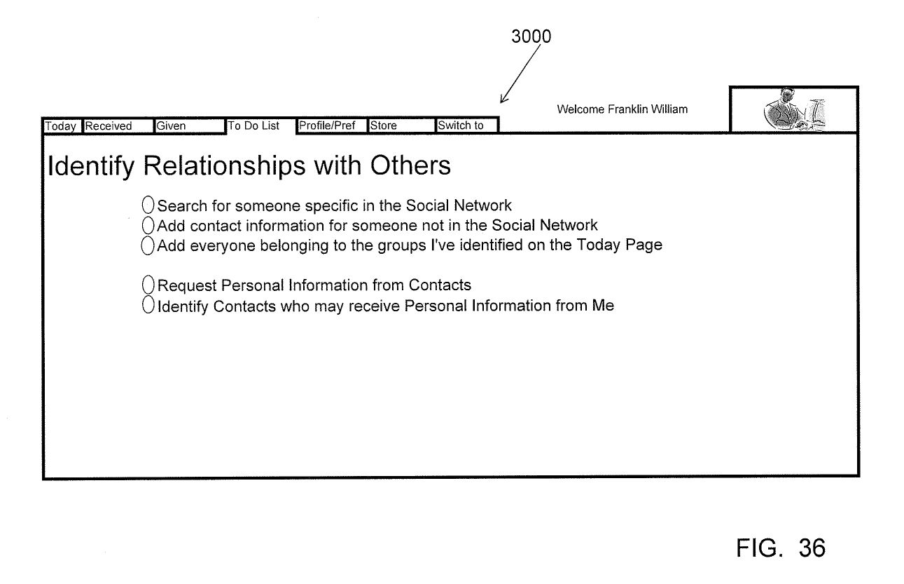

FIG. 36 is a screen shot of a page 3000 identifying Relationships of the users. It identifies options for searching within the Social Network, and specifically within certain Groups. The Communication Service also allows the user to send Communications to a contact not in the Social Network. This type of Relationship will not be able to use all of the features of the Communication Service because the service will not know the Receiver's profile and preferences for Communication. In addition, a user is able to request Personal Information from contacts. For example, if the user would like to receive workplace anniversary dates and birthdates of your co-workers, the user may ask for it using this feature. The user is also able to identify others that they would like to be able to know their personal information such as birthdate. This allows emails to be sent to the user suggesting communication be sent on receiver's relevant dates.

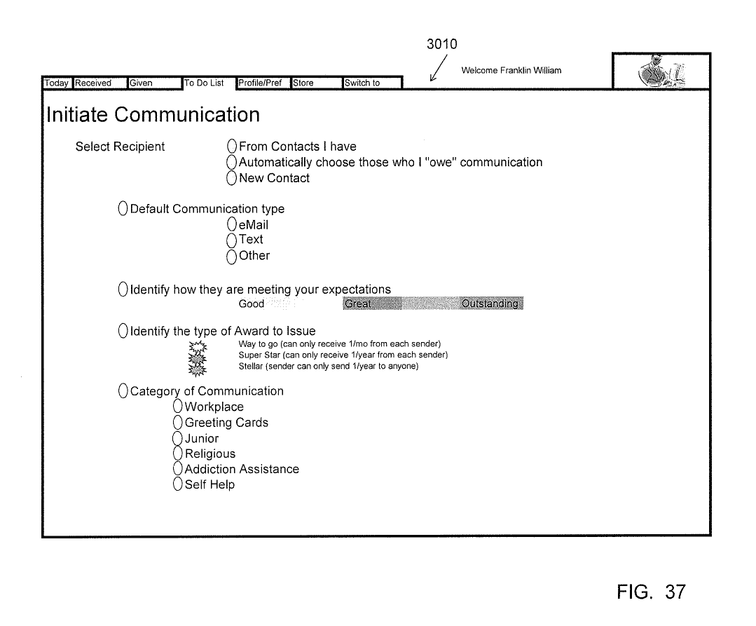

FIG. 37 is a screen shot of a page 3010 used to Initiate Communication. From this page 3010, a Sender is able to identify who the Receiver will be, and the method to send the Communication based upon the default preference of the Receiver (if included in Communication preferences). The Sender identifies how the Receiver is meeting current expectations (which will allow the database to focus the Communication it offers). This page 3010 also allows the Sender to identify the type of Award they want to issue with this Communication. In addition, the Sender may identify which Communication Group to enter.

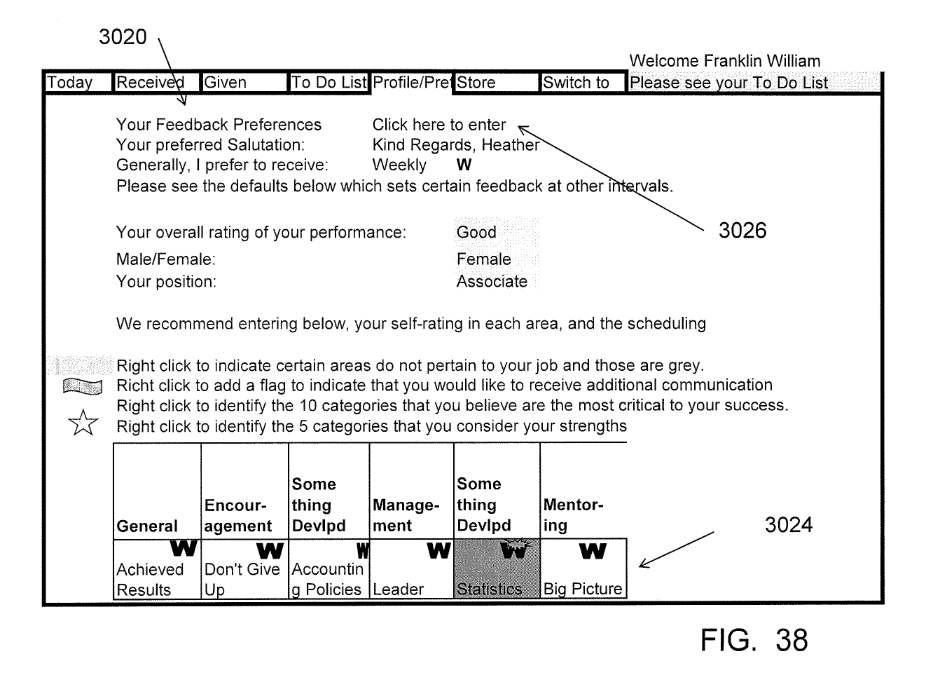

FIG. 38 is a screen shot of a page 3020 showing the Profile and Preferences of the user. The appearance of this page 3020 is much like the Communication Given and Communication Received pages, because it also has a matrix 3024 of the General Critical Category. The preferences and profile information to be entered in this page 3020 includes:
Information of General Critical Categories—this matrix identifies all categories of General Critical. The user should identify areas that do not pertain to their role/job, areas where the user would like additional Communication (and from a Sender specifically), ten categories most critical to the user's success, five categories that the user is most proud of, and he considers as strengths. This information will be considered when determining Communication to be recommended by the Communication Service.
Frequency of Communication Preference in General—An example of options are: Weekly, Biweekly, Monthly, Bimonthly, Semi-Annually, Annually.
Frequency of Communication Preference by Category—Similar options offered, but can be entered based upon each separate Category as those Categories that are critical to success or needing improvement should be communicated on more frequent basis. Other categories may need to only be communicated on occasionally.
Rating Preferences—These Rating Preferences could be entered manually by the user in section 3026, if the user is able to measure his preferences adequately. An example of a Rating Preference is Individual vs. Team=8. If the user would rather not use his own judgment, a survey will also be offered to allow the user to see examples of two Communications, and respond which Communication he prefers. In this fashion, he will be able to determine which would be most satisfactory by reviewing samples. Other embodiments may require the user to answer personal questions about him to allow the Communication Service to provide the Rating. The Rating Preferences will change over time.
Self-Rating of Performance in General—for example, Good=6, Great=8, Outstanding=10. In certain embodiments, an additional Needs Improvement=5 rating will be offered.
Self-Rating of Performance by Category—same example as in General, but the user will respond to each separate Category, or those Categories deemed important to him.
Preference of Communication Method—text, email, tweet, etc.
Miscellaneous—Preferred Salutation, Sex

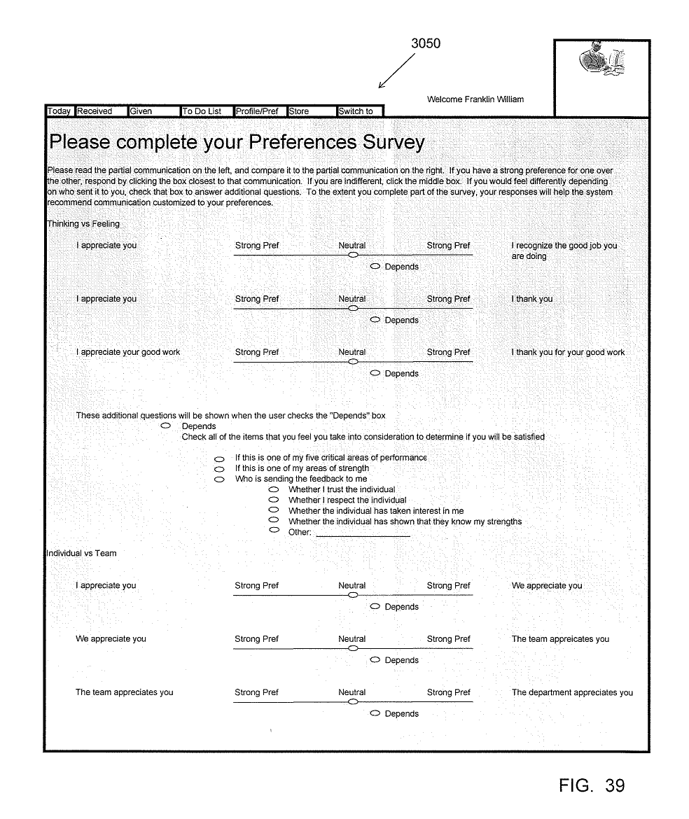

FIG. 39 is a screen shot of a page 3050 asking for User Survey preferences. Sample partial or complete Communication will be displayed to allow the user to determine which sample he most prefers. In addition, if the user's choice would be dependent on other factors, the user has the option to identify to the service those additional factors.

While the preferred embodiment of the invention has been illustrated and described, as noted above, many changes can be made without departing from the spirit and scope of the invention. Accordingly, the scope of the invention is not limited by the disclosure of the preferred embodiment. Instead, the invention should be determined entirely by reference to the claims that follow.

The embodiments of the invention in which an exclusive property or privilege is claimed are defined as follows:

1. A method performed by a computer-based device for forming a communication, the method comprising:
receiving at least one variable identifying an area of communication;
receiving information associated with one or more users;
receiving a plurality of variables, each variable relevant to forming a communication within a previously defined communication category;
generating a communication structure based on at least two of the received variables identifying the area of communication, the received user information or the received plurality of variables;
identifying communication fragments based on the generated communication structure;
selecting communication fragments from those identified;
forming a communication based upon the selected communication fragments; and
outputting the formed communication.

2. The method of claim 1, wherein receiving the at least one variable identifying the area of communication is based on at least one of a user selection or previously stored information associated with the one or more users.

3. The method of claim 1, wherein the communication structure identifies at least one of a communication fragment or a group of fragments, wherein each of the fragment groups comprise a plurality of communication fragments.

4. The method of claim 3, wherein each of the identified fragment groups identifies at least one of an additional variable associated with one or more users, an additional variable associated with the area of communication, an additional variable relevant to forming a communication within the fragment group, or a second group of fragments, wherein each of the second fragment groups comprise a plurality of communication fragments.

5. The method of claim 4, wherein the each of the second identified fragment groups identifies at least one of an additional variable associated with one or more users, an additional variable associated with the area of communication, an additional variable relevant to forming a communication within the group of fragments, or a third group of fragments, wherein each of the second fragment groups comprise a plurality of communication fragments.

6. The method of claim 5, wherein selecting comprises selecting at least one communication fragment group from one of the identified fragment groups.

7. The method of claim 6, wherein at least one fragment of the plurality of communication fragments is associated with a selected fragment group from the at least one fragment groups.

8. The method of claim 7, wherein at least one fragment group comprises interchangeable fragments.

9. The method of claim 8, wherein each interchangeable fragment is associated with one or more parameters, wherein the parameters are the associated fragment group, the received variables, the received user information, or the identified variables.

10. The method of claim 1, wherein forming the communication comprises combining the selected communication fragments based on an order associated with the selection.

11. The method of claim 1, wherein selecting communication fragments comprises selecting from those identified based on at least one of a random selection, a variable related to preference of length of communication or a prioritization of identified communication fragments prioritization that is based on number of associated variables or pre-defined relevance of associated variables.

12. A system comprising:
an output device;
a memory device configured to store information associated with one or more users;
a processing device in data communication with the output device and the memory device, the processing device configured to:
receive at least one variable identifying an area of communication from at least one of a user interface device or the stored information;
receive information associated with one or more users from at least one of the user interface device or the stored information;
receive a plurality of variables from at least one of the user interface device or the stored information, each variable relevant to forming a communication within a predefined communication category;
generate a communication structure based on at least two of the received variable identifying the area of communication, the received user information or the received plurality of variables;
identify communication fragments based on the generated communication structure;
select communication fragments from those identified;
form a communication based upon the selected communication fragments; and
output the formed communication to the output device.

13. The system of claim 12, wherein receiving the at least one variable identifying the area of communication is based on at least one of a user selection or previously stored information associated with the one or more users.

14. The system of claim 12, wherein the communication structure identifies at least one of a communication fragment or a group of fragments, wherein each of the fragment groups comprise a plurality of communication fragments.

15. The system of claim 14, wherein the each of the first identified fragment groups identifies at least one of an additional variable associated with one or more users, an additional variable associated with the area of communication, an additional variable relevant to forming a communication within the fragment group, or a second group of fragments, wherein each of the second fragment groups comprise a plurality of communication fragments.

16. The system of claim 15, wherein the each of the second identified fragment groups identifies at least one of an additional variable associated with one or more users, an additional variable associated with the area of communication, an additional variable relevant to forming a communication within the group of fragments, or a third group of fragments, wherein each of the second fragment groups comprise a plurality of communication fragments.

17. The system of claim 16, wherein the processing device selects at least one communication fragment group from one of the identified fragment groups.

18. The system of claim 17, wherein at least one fragment of the plurality of communication fragments is associated with a selected fragment group from the at least one fragment groups.

19. The system of claim 18, wherein at least one fragment group comprises interchangeable fragments,

20. The system of claim 19, wherein each interchangeable fragment is associated with one or more parameters, wherein the parameters are the associated fragment group, the received variables, the received user information, or the identified variables.

21. The system of claim 12, wherein forming the communication comprises combining the selected communication fragments based on an order associated with the selection.

22. The system of claim 12, wherein the processing device selects communication fragments by selecting from those fragments identified based on at least one of a random selection, a variable related to preference of length of communication or a prioritization of identified communication fragments prioritization that is based on number of associated variables or pre-defined relevance of associated variables.
